(19) United States
(12) Patent Application Publication
(10) Pub. No.: US 2018/0094007 A1
(43) Pub. Date: Apr. 5, 2018

(54) EPOXY PHOSPHONATE ESTER AS A COUPLING AGENT FOR TRANSITION METAL AND METAL OXIDE SURFACES

(71) Applicant: The Curators of the University of Missouri, Columbia, MO (US)

(72) Inventor: Thomas P. Schuman, Rolla, MO (US)

(21) Appl. No.: 15/821,181

(22) Filed: Nov. 22, 2017

Related U.S. Application Data
(62) Division of application No. 14/925,712, filed on Oct. 28, 2015.

(51) Int. Cl. C07F 7/28; C07F 7/00; C08K 9/04; C07F 5/06

(52) U.S. Cl. CPC C07F 7/28; C07F 7/003; C07F 5/069; C08K 9/04

(57) ABSTRACT

A method for surface modification of a substrate comprising surface oxide and/or hydroxy groups, with a compound comprising an ester group and an epoxy ring, wherein the epoxy group remains intact after the reacting. A method for surface modification of a substrate comprising surface oxide and/or hydroxy groups, with a compound comprising an ester group and a functionalized epoxy ring, wherein the functionalized epoxy group remains intact after the reacting. A composite material comprising surface-modified metal oxide nanoparticles dispersed within a polymeric material, wherein the surface modification comprises a compound comprising an ester group and an epoxy ring is also described.

### RELATED APPLICATIONS

This is a divisional application of U.S. patent application Ser. No. 14/925,712, filed Oct. 28, 2015, entitled EPOXY PHOSPHONATE ESTER AS A COUPLING AGENT FOR TRANSITION METAL AND METAL OXIDE SURFACES, incorporated by reference herein.

### FEDERALLY SPONSORED RESEARCH/DEVELOPMENT PROGRAM

This invention was made, as least in part, with government funding under U.S. Army Medical Research and Material Command (USAMRMC) grant #W81XWH-11-1-0805. Accordingly, the United States Government has certain rights in the invention.

### BACKGROUND OF INVENTION

### Field of the Invention

The present invention relates to a method for preparing a surface-functionalized substrate, utilizing a compound comprising an ester group and an epoxy ring. The substrate generally having an oxide-containing or hydroxy-containing surface which will generate an anchor point for the compound comprising an ester group and an epoxy ring.

### Description of the Prior Art

Organic molecules have been used to form monolayers on variety of surfaces, allowing for the tuning of important surface and interfacial parameters that give rise to desired electronic, optical, surface chemical, and/or corrosion protective properties. Alumina and other transition metal oxides are widely found in many applications including but not limited to, support for the catalysts, organometallic, metal-organic and luminescent compounds, structural fillers for dental applications, and pre-concentration reactors to name a few. The area of organic-inorganic hybrid materials is a rapidly expanding field of materials chemistry due to novel properties and functionalities obtained through tuning of the chemical structure.

One area under investigation is modification of the surface of materials used in the biomedical field, such as orthopedic and dental implants, prostheses, venous catheters, biosensors, and pharmaceutical agents. It is the surface of a biomaterial which first comes into contact with the living body when the biomaterial is placed in the body. Therefore, the initial response of the living body to the biomaterial depends on its surface properties. A poorly biocompatible surface will evoke a biological response (foreign body response) and the biomaterial will be unable to provide the needed function. Commonly used materials do not always possess the surface properties necessary for biomaterials. Thus, most conventional materials need surface modification if they are going to be utilized as biomaterials.

One approach to solve this problem is to introduce functional groups to either the surface of the biomaterial, or to a modifying molecule, for chemical reaction between the biomaterial surface and the modifying molecule. Possible modifying molecules include a variety of molecules such as hydrophilic polymers (e.g., poly(ethylene glycol) (PEG)), albumin, heparin, and phospholipids. A technique to apply surface coupling agents to an inorganic surface (e.g., transition metal, transition metal oxides) for strength, wetting, adhesion, and/or as a corrosion barrier, while preserving sensitive chemical groups, should be of interest to materials engineers in biomedical, catalyst, sorbent, sensor, ceramic-based electronic, sorbent extraction, molecule purification or exchange, or corrosion fields. Phosphonic acids and their derivatives (esters, salts) have been used to successfully modify a variety of metal oxide materials, and are highly promising coupling molecules to allow the anchoring of very useful organic molecules with different functionality to inorganic solids.

Relatively little attention has been directed to the preparation and reactions of dialkyl or alkylphosphonates with an epoxy group in either the α, β or β,γ positions. The use of these alkyl epoxy-phosphonates as a coupling agent to anchor useful organic molecules to the surface of metal-oxide nanoparticles is a promising avenue for the introduction of sensitive chemical groups. The modification process includes the conversion of an alkyl epoxy-phosphonate to an epoxy-phosphonic acid, which could undesirably catalyze the ring opening of the epoxy group to yield a diol in the presence of a protic solvent or at higher concentrations of phosphonic acid. The Applicants have discovered an in situ process of applying an epoxy group to a metal or metal oxide while avoiding epoxy acid-catalyzed hydroloysis. The epoxide can then be used as an avenue to introduce useful modifying molecules.

### SUMMARY OF THE INVENTION

The present invention relates to a method for preparing a surface-functionalized substrate, utilizing a compound comprising an ester group and an epoxy ring. The substrate generally having an oxide-containing or hydroxy-containing surface which will generate an anchor point for the compound comprising an ester group and an epoxy ring.

The present invention further relates to a method for preparing a surface-functionalized substrate, utilizing a compound comprising an ester group and a functionalized epoxy ring. The substrate generally having an oxide-containing or hydroxy-containing surface which will generate an anchor point for the compound comprising an ester group and a functionalized epoxy ring.

In one embodiment, the invention relates to a method for preparing a surface-functionalized substrate, utilizing an epoxy phosphonate ester. The ester groups of the epoxy phosphonate ester can be selectively hydrolyzed in situ without ring-opening the epoxy group prior to reacting with the surface of the substrate. A nucleophile can be added to selectively open the epoxide ring after the reacting of the ester groups with the surface of the substrate.

In a further embodiment, the invention relates to a method for preparing a surface-functionalized substrate, utilizing an epoxy phosphonate ester in which nucleophilic opening of the epoxide occurs prior to reacting of the ester groups with the surface of the substrate.

In a preferred embodiment, the invention relates to an in situ method for selectively hydrolyzing the ester groups of an epoxy phosphonate ester with TMS-Br without ring-opening the epoxy group, such that a free phosphonic acid with the epoxy group intact is produced that allows association with surface oxide and/or hydroxyl groups of a substrate.

### BRIEF DESCRIPTION OF THE DRAWING FIGURES

FIG. 1 shows the ¹³C CPMAS NMR of (a) γ-Al₂O₃-DEOMP; (b) TiO₂-DEOMP; and (c) ZrO₂-DEOMP;

FIG. 2a shows reflectance FTIR for: γ-Al₂O₃: Unmodified γ-Al₂O₃ powders, DEOMP modified γ-Al₂O₃ powders, and the difference spectrum;

FIG. 2b shows reflectance FTIR for: ZrO₂: Unmodified ZrO₂ powders, DEOMP modified ZrO₂ powders, and the difference spectrum;

FIG. 2c shows reflectance FTIR for: TiO₂: Unmodified TiO₂ powders, DEOMP modified TiO₂ powders, and the difference spectrum;

FIG. 3 shows XPS survey spectra of (a) unmodified and (b) DEOMP modified TiO₂ nanoparticles with % atomic concentrations;

FIG. 4 shows XPS survey spectra of (a) unmodified and (b) DEOMP modified γ-Al₂O₃ nanoparticles with % atomic concentrations;

FIG. 5 shows XPS survey spectra of (a) unmodified and (b) DEOMP modified ZrO₂ nanoparticles with % atomic concentrations;

FIG. 6 shows TGA weight loss curves for (a) TiO₂ (control), TiO₂-DEOMP; (b) γ-Al₂O₃ (control), γ-Al₂O₃-DEOMP; and (c) ZrO₂ (control), ZrO₂-DEOMP to show the surface modification as a weight loss of the volatile organic portion of the inorganic-organic surface ligand;

FIG. 7 shows comparison of ¹³C CPMAS spectra of TiO₂-DEOMP with respect to time (a) TiO₂-DEOMP-15 min; (b) TiO₂-DEOMP-30 min; (c) TiO₂-DEOMP-60 min; and (d) TiO₂-DEOMP-120 min;

FIG. 8 shows TGA weight loss curves for TiO₂-DEOMP, as a function of time of reaction;

FIG. 9 shows surface modification of TiO₂ with respect to time: (a) percentile weight loss per gram sample; and (b) calculated ligand surface density (Å²/molecule);

FIG. 10 shows TGA percent sample weight as a function of temperature showing the mass loss of: unmodified TiO₂, TiO₂-DEOMP-30 min., and TiO₂-DEOMP-30 min-sterilized in ethanol;

FIG. 11a shows XPS survey spectra of as-received titanium metal (Ti#1);

FIG. 11b shows XPS survey spectra of acid-treated titanium metal (ATTi#2);

FIG. 11c shows XPS survey spectra of DEOMP modified titanium metal (Ti#3) with % atomic concentrations;

FIG. 12 shows TGA traces showing the mass loss of unmodified Al₂O₃ and Al₂O₃-DEOMP vs. n-butylamine reaction;

FIG. 13 shows Optical Microscopy Images of dispersions in epoxy resin matrix: (a) unmodified γ-Al₂O₃ nanoparticles; and (b) γ-Al₂O₃-DEOMP surface modified nanoparticles; and

FIG. 14 shows FE-SEM cross-sectional images of: (a) Unmodified γ-Al₂O₃-epoxy nanocomposite (10 μm resolution, 3.5 k× magnification); (b) Unmodified γ-Al₂O₃-epoxy nanocomposite (5 μm resolution, 11 k× magnification); (c) γ-Al₂O₃-DEOMP-epoxy nanocomposite (10 μm resolution, 3.5 k× magnification); and (d) γ-Al₂O₃-DEOMP-epoxy nanocomposite (5 μm resolution, 8 k× magnification).

### DETAILED DESCRIPTION OF THE PREFERRED EMBODIMENTS

The present invention concerns a method for preparing a surface-functionalized substrate comprising: providing a substrate having a surface, wherein the surface comprises an oxide and/or an —OH group thereon; providing a compound comprising an ester group and an epoxy ring; and reacting the compound with the oxide and/or —OH group so as to yield the surface-modified substrate, and the epoxy ring remaining intact after the reacting. In one embodiment, the surface of substrate comprises a plurality of oxide and/or —OH groups, and the compound reacts with at least two moieties from the group consisting of oxide and —OH groups. In a further embodiment, the compound comprises two ester groups. In a preferred embodiment, the compound is a phosphonate.

In a more preferred embodiment the compound is O,O-dialkyl oxiran-2-yl methyl phosphonate ester, wherein the alkyl group is C₁-C₆ alkyl, or O,O-di(alkoxyalkyl) oxiran-2-yl methyl phosphonate ester, wherein the alkoxyalkyl group is C₁-C₃alkoxyC₁-C₂alkyl. The O,O-dialkyl oxiran-2-yl methyl phosphonate ester is preferably O,O-dimethyl oxiran-2-yl methyl phosphonate ester.

In one embodiment, a single molecule of the compound comprising two ester groups reacts with at least two moieties from the group consisting of oxide and —OH groups. In another embodiment, a single molecule of the compound comprising two ester groups reacts with three moieties from the group consisting of oxide and —OH groups. Scheme 1 is a schematic representation of O,O-diethyl oxiran-2-yl methyl phosphonate ester bonding modes to a substrate surface comprising —OH groups.

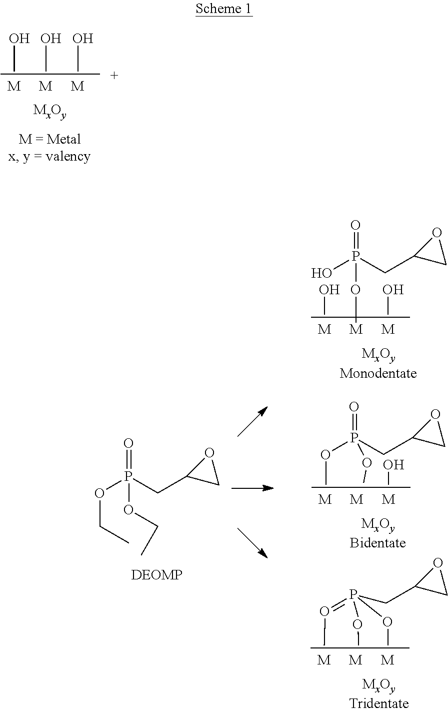

In a further embodiment, the substrate comprises a metal. In a preferred embodiment, the substrate comprises a metal selected from the group consisting of groups 1B, 2B, 4B, 5B, 6B, 7B, 8, 3A, 4A, 5A, the lanthanides, the actinides, and mixtures thereof, of the periodic table (Handbook of Chemistry and Physics, 60^{th} edition, 1979-1980). In a further embodiment the metal is an alloy. In another embodiment, the metal is selected from the noble metal group. In more preferred embodiment the substrate comprises a metal selected from the group consisting of titanium, zirconium, iron, nickel, aluminum, copper, stainless steel, NiTi alloy, brass, and alloys and mixtures thereof. In another preferred embodiment, the substrate comprises a metal oxide selected from the group consisting of titanium oxide, zirconium oxide, aluminum oxide, and mixtures thereof.

In one embodiment, the substrate is in the form of particles, nanoparticles, scintered powder, and free powder. The term “scintered powder” as used herein encompasses a powder metal that has been heated to join the powder into a porous but solid material, like a sponge. This process creates high surface area solids. The term “free powder” as used herein encompasses powders consisting of freely flowing discrete particles. The term “nanoparticle” as used herein encompasses particles having a maximum dimension (in any one dimension) on the order of from about 1 nm to about 100 nm.

In one embodiment, at least about 10% of —OH groups present on the substrate surface react with the compound comprising an ester group and an epoxy ring. In a further embodiment, from about 10% to about 90% of —OH groups present on the substrate surface react with the compound comprising an ester group and an epoxy ring. In a preferred embodiment, from about 40% to about 70% of —OH groups present on the substrate surface react with the compound comprising an ester group and an epoxy ring. In another embodiment, at least about 90% of surface hydroxyl groups are converted to phosphonates.

In some embodiments, the surface density coverage of the metal with the compound comprising an ester group and an epoxide ring is at less than about 100 Å²/molecule. In another embodiment, the surface density coverage of the metal with the compound comprising an ester group and an epoxide ring is from about 20 Å²/molecule to about 80 Å²/molecule. In a preferred embodiment, the surface density coverage of the metal with the compound comprising an ester group and an epoxide ring is from about 25 Å²/molecule to about 60 Å²/molecule. In a most preferred embodiment, the surface group density is about 20 Å²/molecule. In a preferred embodiment, the metal is a metal oxide. In a more preferred embodiment, the metal oxide is selected from the group consisting of titanium oxide, zirconium oxide, and aluminum oxide. As used herein, surface density coverage refers to the number of surface groups (e.g., the compound comprising an ester group and an epoxy ring) on the surface of the surface-modified substrate. The method of calculation of surface density coverage would be known to one of ordinary skill in the art.

A preferred embodiment provides a method for preparing a surface-functionalized substrate comprising: providing a substrate having a surface, wherein the surface comprises an oxide and/or an —OH group thereon; providing a compound comprising an ester group and an epoxy ring; and in situ reacting the compound with the oxide and/or the —OH group so as to yield the surface-modified substrate and the epoxy ring remaining intact after the reacting. In a more preferred embodiment, the reacting comprises hydrolyzing the compound in the presence of the substrate. Specifically, the ester groups of the compound are hydrolyzed without opening the epoxide ring. During this process, as-formed phosphonic acid reacts with the surface oxide and/or the hydroxyl groups of the substrate surface rather than self-catalyzing the undesirable ring opening of the epoxy ring. A preferred embodiment for the in situ hydrolysis involves addition of trimethylsilyl bromide (TMSBr). A more preferred embodiment for the in situ hydrolysis involves addition of TMSBr, followed by the addition of an alcohol (e.g., methanol, ethanol).

Another embodiment further comprises addition of a nucleophile. In one embodiment, the nucleophile is selected from the group consisting of amines, alcohols, thiols, carboxylates, Grignard reagents, and carbon anions. In another embodiment, the nucleophile is selected from the group consisting of telechelic macromolecules, proteins, enzymes, proteins, polysaccharides, antibodies, antigens, hydrophilic polymers, and oligonucleotides. In another embodiment, the nucleophile comprises a linker agent and a molecule selected from the group consisting of telechelic macromolecules, proteins, enzymes, proteins, polysaccharides, antibodies, antigens, and oligonucleotides. The linker agent can be any synthetically appropriate linker compatible with the surface-functionalized substrate and the nucleophile.

An embodiment also concerns a method for preparing a surface-functionalized substrate comprising: providing a substrate having a surface, wherein the surface comprises an oxide and/or an —OH group thereon; providing a compound comprising an ester group and a functionalized epoxy ring; and reacting the compound with the oxide and/or —OH group so as to yield the surface-functionalized substrate. A functionalized epoxy ring is one that has been ring-opened (reacted) with a nucleophile. The nucleophiles are as discussed above. In one embodiment, the surface of substrate comprises a plurality of oxide and/or —OH groups, and the compound reacts with at least two moieties from the group consisting of oxide and —OH groups. In a further embodiment, the compound comprises two ester groups. In a preferred embodiment, the compound is a phosphonate. In a more preferred embodiment the compound is the functionalized epoxy derivative of O,O-dialkyl oxiran-2-yl methyl phosphonate ester, wherein the alkyl group is C₁-C₆alkyl or O,O-di(alkoxyalkyl) oxiran-2-yl methyl phosphonate ester, wherein the alkoxyalkyl group is C₁-C₃alkoxyC₁-C₂alkyl. The O,O-dialkyl oxiran-2-yl methyl phosphonate ester is preferably O,O-diethyl oxiran-2-yl methyl phosphonate ester.

In an embodiment, a single molecule of the compound comprising two ester groups reacts with at least two moieties from the group consisting of oxide and —OH groups. In another embodiment, a single molecule of the compound comprising two ester groups reacts with three moieties from the group consisting of oxide and —OH groups. The bonding modes are as depicted in Scheme 1 above.

In a further embodiment, the substrate comprises a metal. In a preferred embodiment, the substrate comprises a metal selected from the group consisting of groups 1B, 2B, 4B, 5B, 6B, 7B, 8, 3A, 4A, 5A, the lanthanides, the actinides, and mixtures thereof, of the periodic table (Handbook of Chemistry and Physics, 60^{th} edition, 1979-1980). In a further embodiment the metal is an alloy. In another embodiment, the metal is selected from the noble metal group. In more preferred embodiment the substrate comprises a metal selected from the group consisting of titanium, zirconium, iron, nickel, aluminum, copper, stainless steel, NiTi alloy, brass, and alloys and mixtures thereof. In another preferred embodiment, the substrate comprises a metal oxide selected from the group consisting of titanium oxide, zirconium oxide, aluminum oxide, and mixtures thereof.

In one embodiment, the substrate is in the form of particles, nanoparticles, scintered powder, and free powder. The terms “scintered powder,” “free powder,” and “nanoparticle” are as defined above.

In one embodiment, at least about 10% of —OH groups present on the substrate surface react with the compound comprising an ester group and a functionalized epoxy ring. In a further embodiment, from about 10% to about 90% of —OH groups present on the substrate surface react with the compound comprising an ester group and a functionalized epoxy ring. In a preferred embodiment, from about 40% to about 70% of —OH groups present on the substrate surface react with the compound comprising an ester group and a functionalized epoxy ring.

In some embodiments, the surface density coverage of the metal with the compound comprising an ester group and a functionalized epoxide ring is at less than about 100 Å²/molecule. In another embodiment, the surface density coverage of the metal with the compound comprising an ester group and a functionalized epoxide ring is from about 10 Å²/molecule to about 80 Å²/molecule. In a preferred embodiment, the surface density coverage of the metal with the compound comprising an ester group and a functionalized epoxide ring is from about 20 Å²/molecule to about 60 Å²/molecule. In a most preferred embodiment, the surface group density is about 20 Å²/molecule. In a preferred embodiment, the metal is a metal oxide. In a more preferred embodiment, the metal oxide is selected from the group consisting of titanium oxide, zirconium oxide, and aluminum oxide. As used herein, surface density coverage refers to the number of surface groups (e.g., the compound comprising an ester group and an epoxy ring) on the surface of the surface-modified substrate. The method of calculation of surface density coverage would be known to one of ordinary skill in the art.

In a preferred embodiment, the present invention concerns a method for preparing a surface-functionalized substrate comprising: providing a substrate having a surface, wherein the surface comprises an oxide and/or an —OH group thereon; providing a compound comprising an ester group and a functionalized epoxy ring; and in situ reacting the compound with the oxide and/or the —OH group so as to yield the surface-modified substrate. In a more preferred embodiment, the reacting comprises hydrolyzing the compound in the presence of the substrate. Specifically, the ester groups of the compound are hydrolyzed without adversely affecting the functionalized epoxide ring. During this process, as-formed phosphonic acid reacts with the surface oxide and/or the hydroxyl groups of the substrate surface rather than self-catalyzing the undesirable reactions of the functionalized epoxy ring. A preferred embodiment for the in situ hydrolysis involves addition of trimethylsilyl bromide (TMSBr). A more preferred embodiment for the in situ hydrolysis involves addition of TMSBr, followed by the addition of an alcohol (e.g., methanol, ethanol).

Various solvents can be used in the above-described method, such as toluene, methylene chloride, THF, acetone, ethanol, methanol, and ethyl acetate. In one embodiment, the reacting further comprises warming above ambient temperature. That is, the reacting comprises warming at least about 40° C.; preferably from about 40° C. to about 150° C.; more preferably from about 60° C. to about 130° C.; and most preferably from about 80° C. to about 115° C. In another embodiment, the reacting comprises warming to the reflux temperature of the solvent, as discussed above. In one embodiment, the mixture of the substrate and the compound is allowed to cool to ambient temperature prior to the addition of trimethylsilyl bromide (TMSBr). In one embodiment, the mixture of substrate, the compound, and TMSBr is warmed above ambient temperature. That is, the mixture is warmed at least about 40° C.; preferably from about 40° C. to about 150° C.; and more preferably from about 50° C. to about 90° C.

An embodiment further provides a surface-modified substrate wherein the modification comprises a compound comprising an ester group and an epoxy ring. In one embodiment, the compound comprising an ester and an epoxy group forms a monolayer on the substrate. The details of the substrate and the compound comprising an ester and an epoxy group are as discussed above.

An embodiment further provides a surface-modified substrate wherein the modification comprises a compound comprising an ester group and a functionalized epoxy group. In one embodiment, the compound comprising an ester and a functionalized epoxy group forms a monolayer on the substrate. The details of the substrate and the compound comprising an ester and a functionalized epoxy group are as discussed above.

An embodiment further provides a composite material comprising surface-modified metal oxide nanoparticles dispersed within a polymeric material, wherein the surface modification comprises a compound comprising an ester and an epoxy group. The details of the compound comprising an ester and an epoxy group are as discussed above. In one embodiment, the metal oxide is selected from the group consisting of group 1B, 2B, 4B, 5B, 6B, 7B, 8, 3A, 4A, 5A, the lanthanides, the actinides, and mixtures thereof. In a preferred embodiment, the metal oxide is selected from the group consisting of titanium oxide, zirconium oxide, and aluminum oxide. In one embodiment, the polymeric material is selected from the group consisting of a two-part thermosetting epoxy or urethane polymer, wherein at least one of the monomers or curing agent resins have nucleophilic groups (e.g., amines, thiols, carboxyl, or phenolic), or comprises acid catalyzed polymerized epoxy or acrylic monomers. In a preferred embodiment, the polymeric material is selected from the group consisting of a two-part thermosetting epoxy polymer or acid catalyzed polymerized acrylic monomers. The surface-modified metal-oxide nanoparticles display improved dispersion quality over unmodified metal oxide nanoparticles. That is, unmodified nanoparticles exhibit larger and clustered agglomerates of nanoparticles than the surface-modified nanoparticles.

### EXAMPLES

The following examples set forth methods in accordance with the invention. It is to be understood, however, that these examples are provided by way of illustration and nothing therein should be taken as a limitation upon the overall scope of the invention.

### Materials

Acetone, methylene chloride, sodium hydroxide, ethyl acetate, toluene, ethanol, hydrochloric acid, and anhydrous magnesium sulfate were purchased from Fisher Scientific (St. Louis, Mo., USA). Triethylphosphite, epibromohydrin, anhydrous toluene, and anhydrous diethyl ether were purchased from Acros Organics (part of Thermo Fisher Scientific, USA). Trimethylsilylchloride (TMSCl), trimethylsilylbromide (TMSBr), 2-ethyl-4-methylimidazole (95%), 4-methyl-1,2-cyclohexanedicarboxylic anhydride (MHHPA), and methanol were purchased from Sigma-Aldrich Co. LLC., USA. γ-Phase aluminum oxide (99%, particle diameter 40 to 80 nm, specific surface area (SSA)=180 m²/g) and titanium dioxide anatase (99.9%, 15 nm, SSA=200 m²/g) were purchased from Alfa Aesar, Ward Hill, Mass., USA. Zirconium oxide (99.9%, D50˜500 nm, BET SSA=15 m²/g) was purchased from Inframat Advanced Materials (Willington, Conn., USA). Titanium grade 2 alloy sheet of thickness 1.6 mm was purchased from McMaster Carr (Chicago, Ill., USA) and cut into 15×15 mm (˜¾″×¾″) samples. Epoxy monomer (epoxy equivalent weight=158) was purchased from Archer Daniels Midland.

### Chemical and Surface Characterization

¹³C CPMAS NMR spectra were measured in a Bruker 400 MHZ FT/NMR. A reference peak for ¹³C CPMAS NMR spectra was assigned from the —CH₂ peak of glycine at 43.3 ppm (Liu et al. J. Magn. Reson. 2002, 155, 15-28; Ballano et al. J. Org. Chem. 2008, 73, 8575-8578). ¹H NMR spectra were obtained on a Varian INOVA 400 MHZ spectrometer (Palo Alto, Calif., USA) using chloroform-d as solvent. The reference peak for ¹H NMR in CDCl₃ was taken as the residual solvent peak at 7.24 ppm and for ¹³C NMR was taken as 77.23 ppm. The reference peak for ³¹P NMR was taken as external standard H₃PO₄ in D₂O with the ³¹P peak at 0.00 ppm.

Diffuse reflectance FTIR measurements were measured with a Nicolet Nexus 470 E.S.P. spectrophotometer (Waltham, Mass., USA) in the mid-IR region (from 4000 cm⁻¹ to 400 cm⁻¹) and were taken by replacing the sample holder of Nicolet Nexus 470 with the Cricket reflectance accessory (Harrick Scientific Corporation, Ossining, N.Y., USA). Thermogravimetric analysis (TGA) was performed on a TA Instruments Q50 thermogravimetric analyzer with a scan rate of 10° C./min scanning from room temperature to 800° C. GC-MS spectra were recorded on Hewlett Packard 5989A Mass Spectrometer (GC/MS & DIP/MS inputs).

X-ray photoelectron spectroscopy (XPS) measurements were taken in a KRATOS AXIS 165 X-ray photoelectron spectrometer using a monochromatic aluminum X-ray source. The analyzed core-level lines were referenced with respect to C(1s) binding energy of 285.2 eV. The signals were deconvoluted with mixed Gaussian-Lorentzian curves (CasaXPS, Casa Software Ltd., Tigenmouth, UK) where the Gaussian character was set at 70% and the Lorentzian character was set at 30%. In comparison, Forget et al. (Appl. Surf Sci. 2003, 205, 44-55) used 80% Gaussian character for de-convolution of curves for the metallic Al(2p) reference peak of 72.7 eV.

Optical microscopy imaging was acquired using a HIROX KH-8700 3D digital microscope (Hirox-USA Inc., Hackensack, N.J., USA). A Hitachi S-4700 FE-SEM was used to acquire secondary electron images of cross sectioned films of prepared composite formulations for examining the quality of dispersion. The cross sectioned samples were wet-abrasive wheel polished. Samples were sputter coated with gold prior to scanning electron microscopic imaging to reduce localized sample charging.

### Synthesis of Ligands

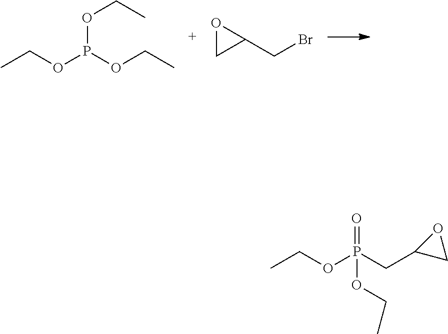

### Example 1

### Synthesis of Diethyl Oxiran-2-ylmethylphosphonate (DEOMP, 1)

The procedure of Griffin and Kundu (J. Org. Chem. 1969, 34, 1532-1539) was followed with modifications. A mixture of epibromohydrin (36.02 g, 0.26 mol) and triethyl phosphate (42.82 g, 0.26 mol) was heated under a nitrogen atmosphere. Ethyl bromide was distilled from the reaction mixture beginning when the temperature reached about 120° C. The reaction mixture was held at 130° C. for 4 hours and then up to 155° C. until the evolution of ethyl bromide ceased. Distillation of the reaction mixture through a 6-in Vigreux column gave 45.00 g (yield=90.0%) of O,O-diethyl oxiran-2-ylmethyl phosphonate ester (DEOMP). Four trials of synthesis were carried out separately to obtain nearly 180 g of DEOMP. The DEOMP crude products were combined and portions fractionally distilled at 1.1 mm Hg (b.p.=93.5° C.) or 1.5 mm Hg (B.P.=102° C.). The yield in each distillation was 32.00 g of pure DEOMP (for a total yield of 86.86 g of DEOMP), yielding a highly purified, isolated fraction in 59.4% final yield. ¹H NMR (Purity=100% from ¹H NMR, CDCl₃, 400 MHZ): 1.246-1.291 (t, J=7.2 Hz, 6H, —CH₃), 1.732-1.845 (DDD, KH—H=6.4 Hz, KH—H=3.6 Hz, JP—H=15.2 Hz, 1H, —C.H.—), 2.083-2.189 (DDD, KH—H=5.6 Hz, KH—H=3.6 Hz, JP—H=14.8 Hz, 1H, —C.H.), 2.503-2.529 (m, 1H, —OCHH—), 2.752-2.788 (m, 1H, —OCHH—), 3.083-3.129 (m, 1H, —OCH—), 3.990-4.120 (m, 4H, —OCH₂—) ppm.; ¹³C NMR (CDCl₃, 100 MHZ): 16.46 (JP—C=6.0 Hz, —CH₃), 29.52-30.90 (JP—C=138.0 Hz, —CH₂—), 46.82 (JP—C=1.5 Hz, —OCH—), 47.27 (JP—C=7.0 Hz, —OCH₂— ring), 61.94 (JP—C=6.0 Hz, —OCH₂—) ppm.; ³¹P NMR (D₂O, 162 MHZ): 29.83 ppm; IR (CDCl₃) cm⁻¹: 3053, 2984, 2930, 2910, 2872, 1481, 1445, 1409, 1395, 1369, 1348, 1255, 1222, 1164, 1134, 1098, 1053, 1025, 966, 872, 842, 823, 803, 750, 717; GC-MS (Purity=98%): 194 (M⁺), 193 (M⁺-H), 165, 153, 139, 137, 121 (100%), 111, 97, 93, 81, 71, 65, 57.

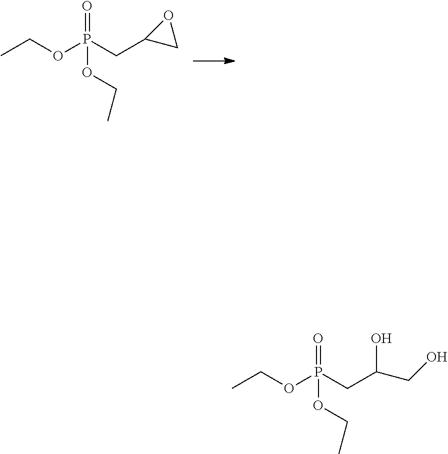

### Example 2

### Synthesis of diethyl 2,3-dihydroxypropylphosphonate (2)

DEOMP (1.00 g, 5.2 mmol) was weighed into a 25 mL round bottom flask and water (5 mL) was added. Ten drops of 1.0 M HCl (˜0.5 mmol) were added to the flask, and the reaction mixture refluxed for 4 hr. with stirring. After 4 hr., the flask was allowed to cool down to room temperature, the water was removed under vacuum suction, and the product was washed with water (4 mL). The product was a very viscous, very pale yellow oil identified as diethyl 2,3-dihydroxypropylphosphonate (2). ¹H NMR (Purity=91% or higher, CDCl₃, 400 MHZ): 1.276 (t, J=7.2 Hz, 3H, —CH₃), 1.280 (t, J=7.2 Hz, 3H, —CH₃), 1.878-2.059 (m, 2H, —PCHH—), 3.461-3.505 (dd, J=11.6 Hz, J=6 Hz, 1H, —CHHOH), 3.623 (d, J=9.8 Hz, 1H, —CHHOH), 3.999-4.123 (m, 5H, —CHOH—, —OCH₂—), 5.258 (s, 2H, —OH) ppm.; ¹³C NMR (CDCl₃, 100 MHZ): 16.47 (—CH₃), 16.52 (—CH₃), 29.16-30.56 (JP—C=140.0 Hz, —PCH₂—), 62.24 (JP—C=6 Hz, —OCH₂—), 62.36 (JP—C=7 Hz, —OCH₂—), 66.81 (JP—C=16 Hz, —CH₂OH), 67.24 (JP—C=3 Hz, —CHOH—) ppm.; IR (CDCl₃) cm⁻¹: 3361 (—OH), 2984, 2929, 2910, 2870, 1806, 1479, 1444, 1393, 1368, 1347, 1315, 1292, 1222, 1164, 1094, 1049, 1028, 967, 882, 862, 836, 808, 780, 721, 691.

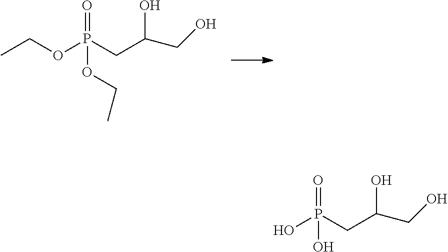

### Example 3

### Synthesis of 2,3-dihydroxypropylphosphonic acid (3)

Toluene (5 mL) was added to a portion of 2 in a round bottom flask. TMSBr (1.4 mL, 10.5 mmol) was added by syringe, followed by methanol (50 μL), and the contents were refluxed overnight. The solvents were removed under reduced pressure for 1.5 hr. at 55° C. to produce crude 2,3-dihydroxypropylphosphonic acid (3). ¹H NMR (CDCl₃, 400 MHZ): 2.059-2.182 (m, 2H, —PCH₂), 3.474 (d, J=5.2 Hz, 2H, —CH₂OH), 4.176-4.238 (m, 1H, —CHOH), 8.811 (s, 2H, —OH) ppm.; ¹³C NMR (CDCl₃, 100 MHZ): 33.04-34.49 (JP—C=144.0 Hz, —PCH₂—), 38.72 (JP—C=19 Hz, —CHOH), 66.63 (JP—C=4 Hz, —CH₂OH) ppm.; IR (CDCl₃) cm⁻¹: 3270 (—OH), 3500-1500 (br, —P(O)(OH)₂), 2955, 2916 (—CH), 1420, 1395, 1344, 1311, 1253, 1174, 1149, 1126, 1077, 996, 941, 866, 816, 783, 735, 687.

### Surface Modification of Substrates

### Example 4

### Surface Modification of Metal Oxide Nanoparticles

γ-Al₂O₃ (5.00 g), TiO₂ (10.00 g), or ZrO₂ (5.00 g) powder was transferred to a 250 mL round bottom flask, and toluene (˜100 mL) was added. The contents were ultrasonicated (FS60H ultrasonic bath with 6 L water bath, Fischer Scientific, St. Louis, Mo., USA) for 1 hour. DEOMP (1, 2.0 g, 10.4 mmol) was added to the round bottom flask, and the mixture was stirred for 30 min. The contents were warmed to reflux, refluxed for ˜15 min, and then allowed to cool to room temperature. TMSBr (6.3 g, 5.3 mL, 39.9 mmol) was added to the reaction mixture using a syringe. The reaction mixture was heated to 50-90° C. and the reaction was continued overnight with stirring.

After overnight reaction, γ-Al₂O₃ or ZrO₂ were recovered by Millipore filtration through a Fluoropore 0.22 um membrane (Fisher Scientific, St. Louis, Mo., USA). The precipitate was washed with toluene (50 mL×3) to remove excess of DEOMP and TMSBr, and dried in a conventional oven at 160° C. overnight.

For TiO₂, the reaction mixture was centrifuged (IEC Clinical Centrifuge, International Equipment Company, a division of Damon, Needham Heights, Mass., USA) for 10-15 minutes and the solvent decanted. The ultrasound dispersion-centrifugation-decantation process was repeated 3 times: 1) add fresh toluene; 2) shake for 15 sec; 3) ultrasonication for 10 min; 4) centrifugation; and 5) decant solvent. Finally, the precipitate was transferred to a watch glass and the material was dried at 160° C. in a conventional oven overnight (16 hr.).

### Example 5

### Analysis of Surface Modification of Metal Oxide Nanoparticles with DEOMP

### ¹³C CPMAS NMR

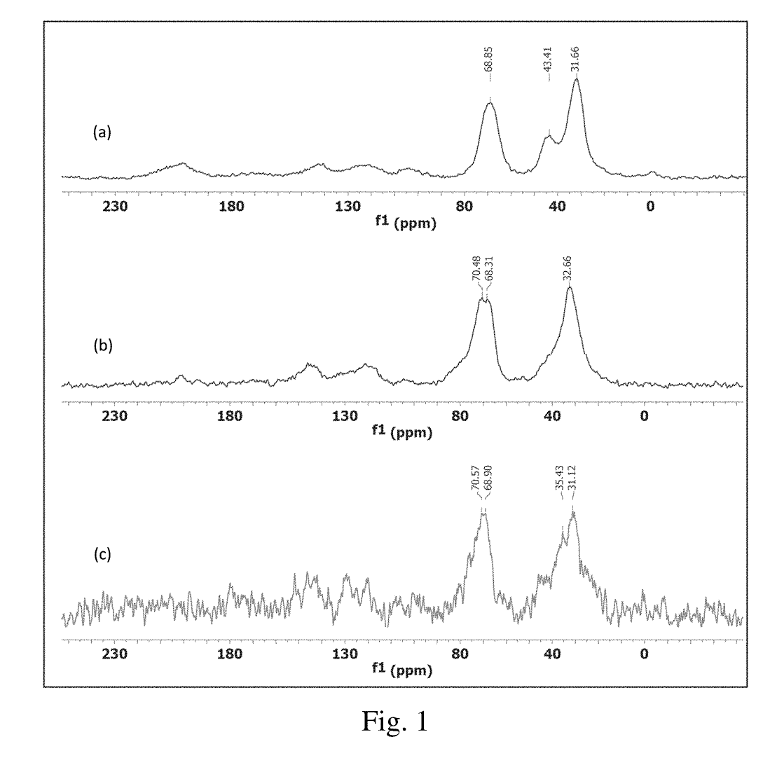

The ¹³C CPMAS NMR of DEOMP modified γ-Al₂O₃ nanoparticles (λ-Al₂O₃-DEOMP) showed three broad carbon peaks at 31.7 ppm (—P(O)CH₂—) and 68.9 ppm (-oxirane) (FIG. 1a), which appeared similar to the solution ¹³C NMR absorbance patterns for the unbound ligand. However, with the surface bound ligand, CP MAS patterns showed slightly downfield shifts compared to solution spectra. Absorption at 43.4 ppm (P(═O)—CH₂CH—OH) as a shoulder adjacent to the larger 31.7 ppm absorbance was assigned to ring opened (diol) surface phosphonate ligand, as was a small shoulder at 77 to 85 ppm (—CH₂—OH).

Similarly, the ¹³C CPMAS NMR of DEOMP modified TiO₂ nanoparticles (TiO₂-DEOMP) showed two broad carbon peaks at 32.7 ppm and between 68.3 to 70.5 ppm (FIG. 1b). The peak at around 43 ppm was not fully resolved due to the broadened nature of solid state samples (due to anisotropy and cross polarization) and due to low signal associated with the fewer ring opened phosphonate ligands.

The ¹³C CPMAS NMR of DEOMP modified ZrO₂ nanoparticles (ZrO₂-DEOMP) showed two broad carbon peaks between 31.1 to 35.4 ppm and 68.9 to 70.6 ppm, respectively, although the resolution of the spectrum was less than observed for the other powder samples. The ZrO₂-DEOMP sample also showed shoulder absorptions at 41 to 46 ppm (P(═O)—CH₂CH—OH) and at 78 to 83 ppm (—CH₂—OH), corresponding to a quantity of ring opened oxirane (FIG. 1c). It is known that solid state samples show broader peaks and less resolution compared to solution samples because of solid anisotropy.

### Diffuse Reflectance FTIR

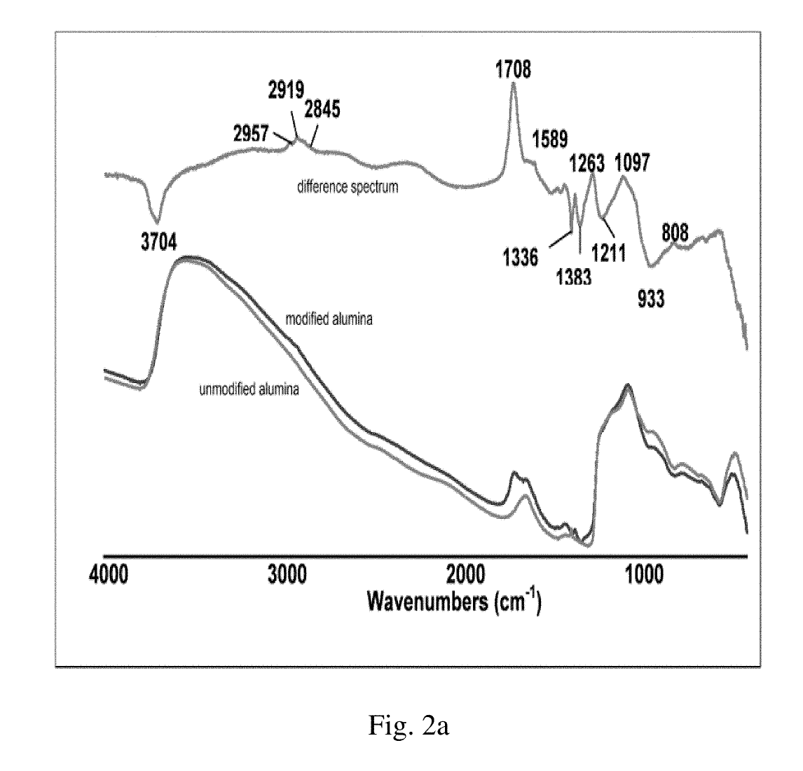

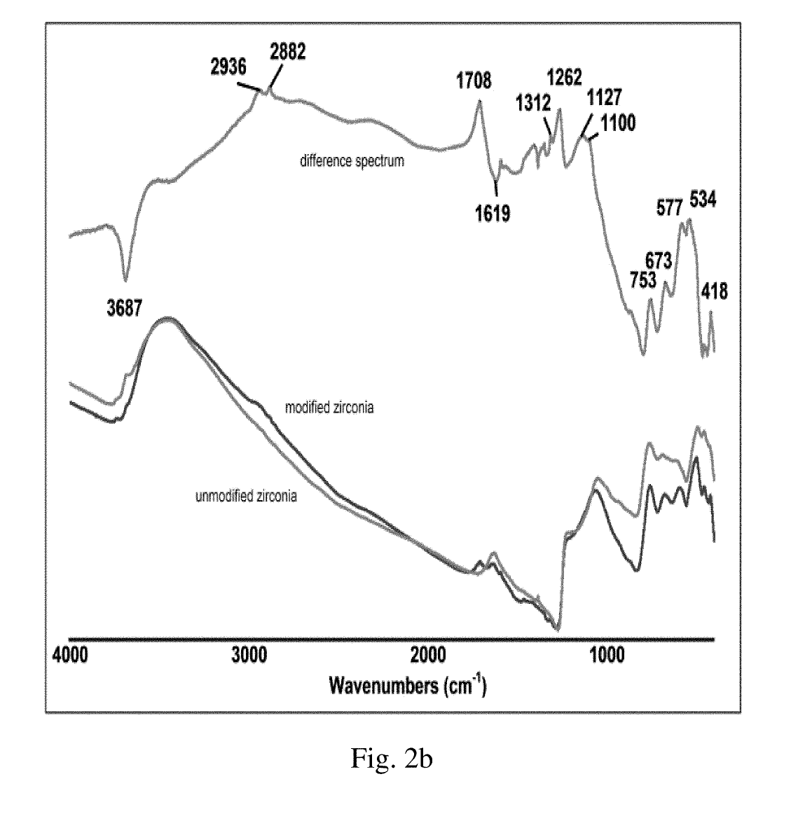

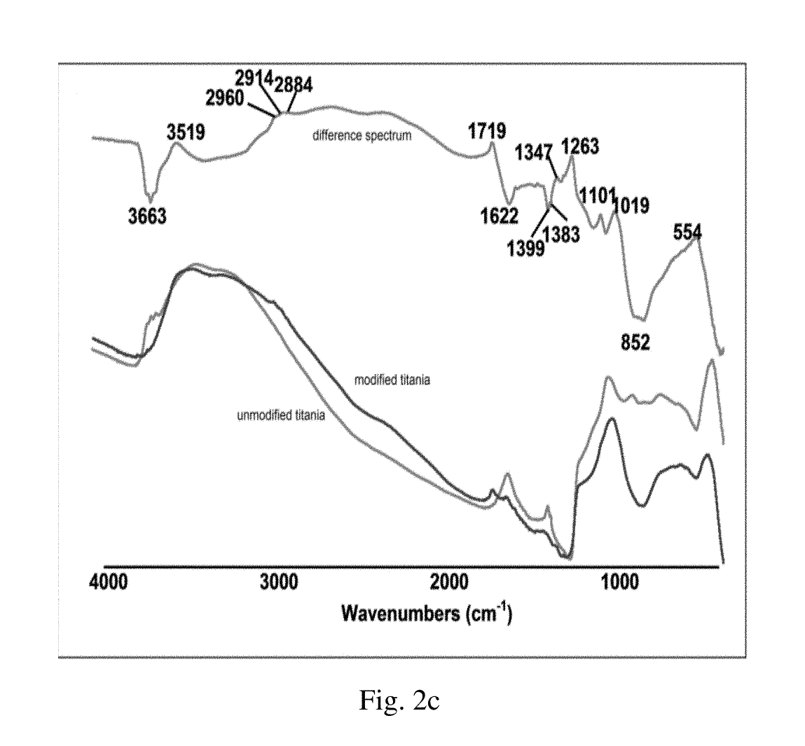

Diffuse reflectance FTIR was utilized to obtain surface-specific FTIR absorption spectra. Spectral subtraction was calculated to indicate addition/removal of functional groups. FTIR's were measured of a 1:4 oxide to KBr ratio sample composition with 256 scans at 4 cm⁻¹ resolution with Kubelka-Munk correction. Reflectance FTIR analyses of the metal oxide nanoparticles (e.g., metal=λ-Al₂O₃, ZrO₂, TiO₂) showed the incorporation of in situ hydrolyzed DEOMP (see FIG. 2a-2c).

Spectral subtraction provided positive absorption difference for added functional groups and negative absorptive differences for removed functional groups. For instance, negative peaks at 3704 cm⁻¹ for γ-Al₂O₃-DEOMP, 3687 cm⁻¹ for ZrO₂-DEOMP, and 3663 cm⁻¹ for TiO₂-DEOMP indicated the disappearance of some surface hydroxyl groups, suggesting that they were consumed in formation of covalent bonds with the hydrolyzed DEOMP chromophore during the surface modification.

Peaks at 1708 cm⁻¹, 1263 cm⁻¹ and 1097 cm⁻¹ for γ-Al₂O₃-DEOMP; 1708 cm⁻¹, 1262 cm⁻¹, 1127 cm⁻¹, and 1100 cm⁻¹ for ZrO₂-DEOMP; and 1719 cm⁻¹, 1263 cm⁻¹, 1101 cm⁻¹, 1019 cm⁻¹ for TiO₂-DEOMP indicate the incorporation of DEOMP on the surface of the metal oxide nanoparticles, which correspond to P—OH, P═O, and P—O—C group absorptions, respectively. The FTIR vibrations due to the oxirane ring overlaps the FTIR stretches of the metal oxides in the region 1,000-500 cm⁻¹. We did not confirm the presence of the oxirane ring in the DEOMP modified metal oxide powders using the diffuse reflectance FTIR analysis.

### XPS Analyses

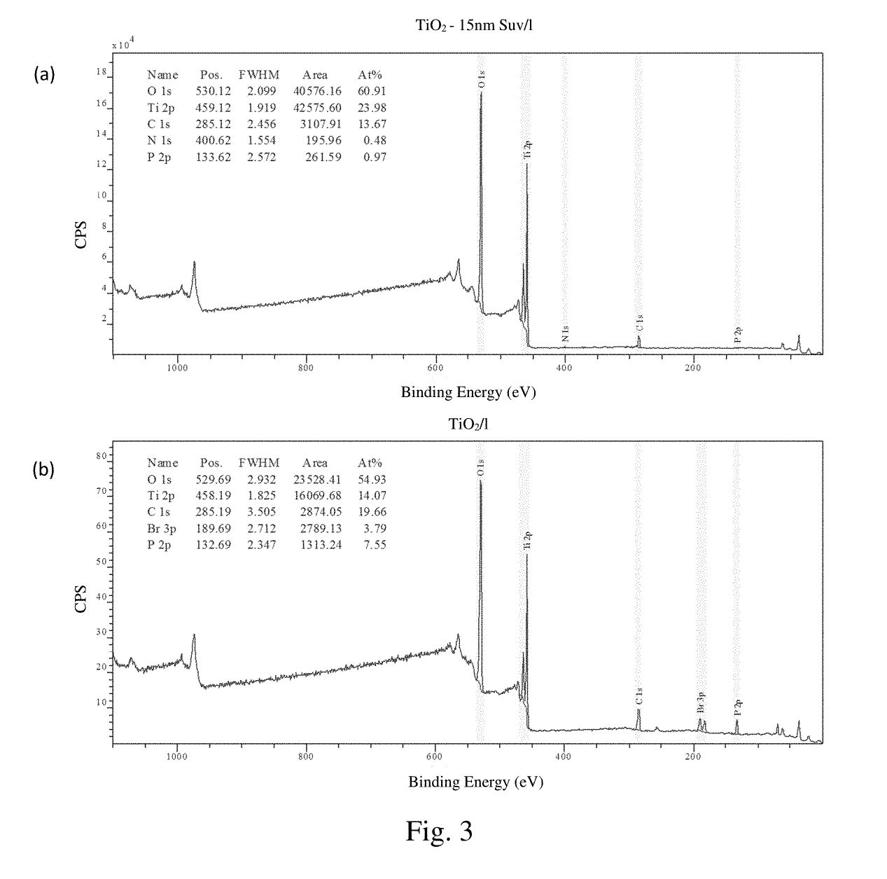

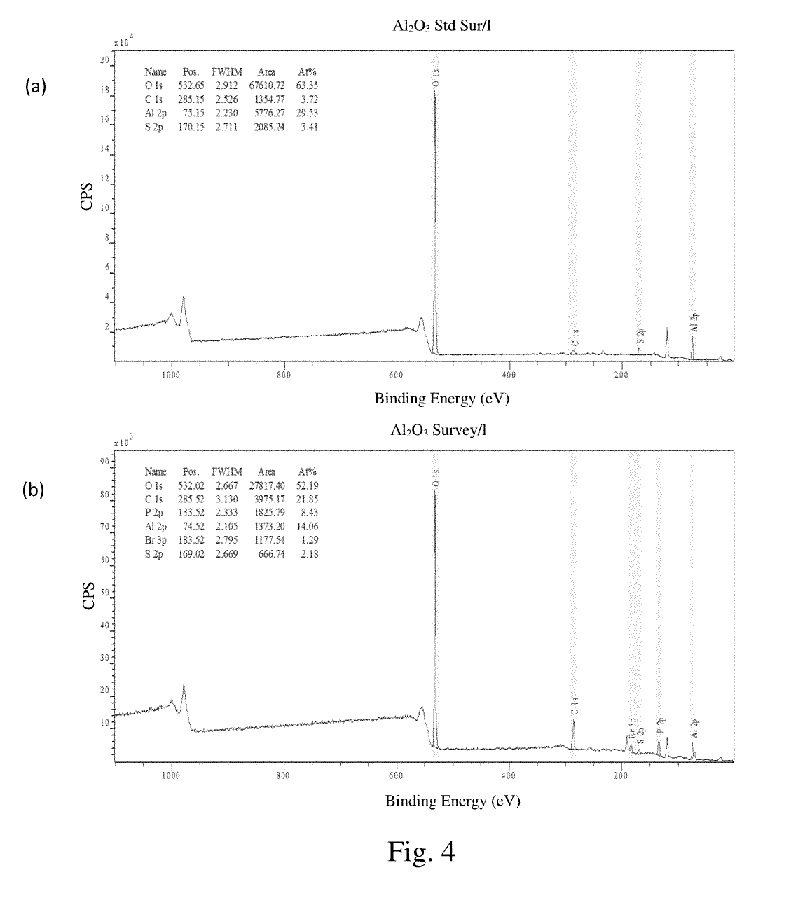

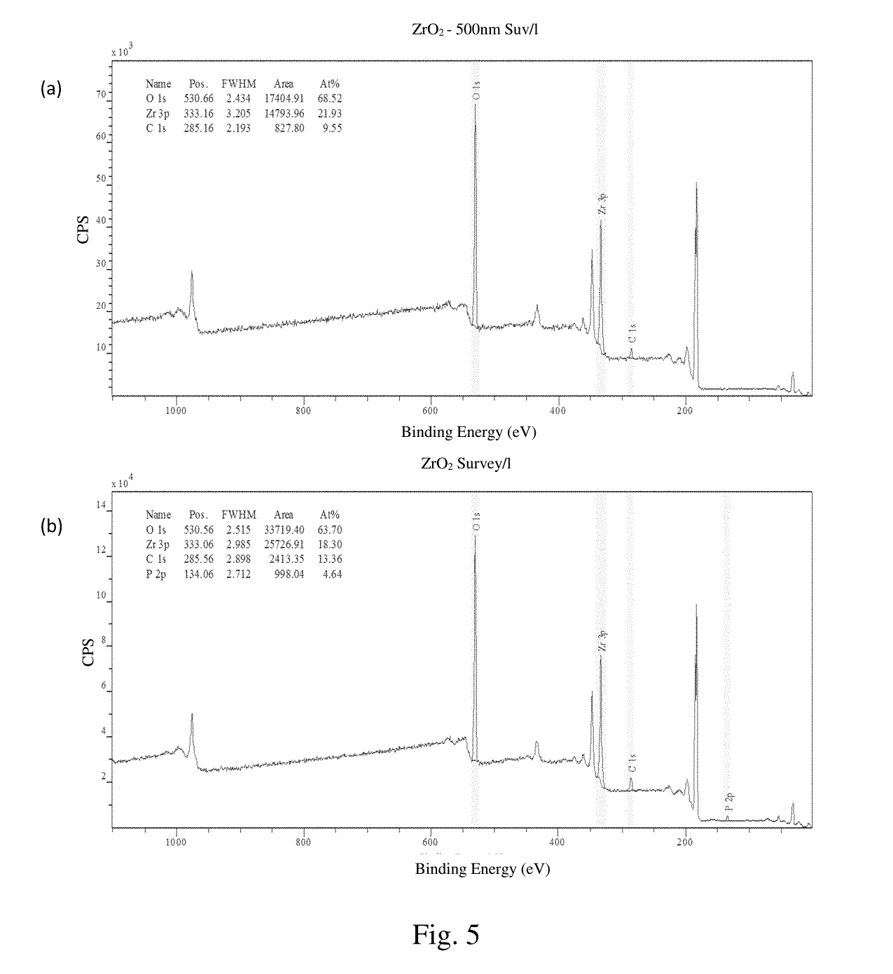

Wide scan, XPS survey spectra of unmodified and DEOMP modified metal oxide powders directly showed the incorporation of the modifier DEOMP as surface phosphorus content compared to the unmodified powders. For data see Tables 1 and 2 and FIG. 3-5. Phosphorus atomic percent values obtained for TiO₂-DEOMP were significantly higher (>3×) compared to Siddabattuni et al. (ACS Appl. Mater. Interfaces, 2013, 5, 1917). The P atomic percent values were also slightly higher than that of Hofer et al. (Langmuir, 2001, 17, 4014). Further, in all modified powder samples, the amount of carbon content was increased at the expense of metal oxide content, where the amount of surface metal element concentration was decreased.

TABLE 1
XPS atomic survey scan concentration data for unmodified
and DEOMP modified metal oxide nanoparticles

| | Atomic Concentration % | | | | | | | | | |
|---|---|---|---|---|---|---|---|---|---|---|
| Nano Powders | Ti | Al | Zr | C | O | P | Br | N | S | |
| (SSA) | (2p) | (2p) | (3d) | (1s) | (1s) | (2p) | (3p) | (1s) | (2p) | F |
| γ-Al₂O₃ | — | 29.53 | — | 3.72 | 63.35 | — | — | — | 3.41 | — |
| (40-80 nm) | | | | | | | | | | |
| γ-Al₂O₃- | — | 14.06 | — | 21.85 | 52.19 | 8.43 | 1.29 | — | 2.18 | — |
| DEOMP | | | | | | | | | | |
| TiO₂ (15 nm) | 23.98 | — | — | 13.67 | 60.91 | 0.97 | — | 0.48 | — | — |
| TiO₂-DEOMP | 14.07 | — | — | 19.66 | 54.93 | 7.55 | 3.79 | — | — | — |
| ZrO₂ | — | — | 21.93 | 9.55 | 68.52 | — | — | — | — | — |
| (500 nm) | | | | | | | | | | |
| ZrO₂-DEOMP | — | — | 18.30 | 13.36 | 63.70 | 4.64 | — | — | — | — |

TABLE 2
XPS binding energy assignments of different element chemical groups
of unmodified and DEOMP modified metal oxide nanoparticle powders
that were utilized for deconvolution of the surface composition signal
of high resolution photoelectron spectra

| | Unmodified | Al₂O₃- | Unmodified | TiO₂- | Unmodified | ZrO₂- |
|---|---|---|---|---|---|---|
| Orbital | Al₂O₃ | DEOMP | TiO₂ | DEOMP | ZrO₂ | DEOMP |
| C(1s) | 285.21 | 285.16 | 285.22 | 285.15 | 285.20 | 285.19 |
| C(1s) | 289.39 | 286.54 | 286.56 | 286.67 | 284.58 | 286.41 |
| C(1s) | | 288.25 | 289.40 | | | |
| O(1s) | 530.69 | 530.70 | 528.81 | 528.29 | 530.43 | 530.31 |
| O(1s) | 530.04 | 532.19 | 529.64 | 529.43 | 531.63 | 531.63 |
| O(1s) | | | 531.66 | 531.28 | | 533.36 |
| P(2p) | — | 133.95 | 132.99 | 131.77 | 133.75 | |
| P(2p) | — | 134.65 | — | 132.85 | 134.59 | |
| Al(2p) | 72.83 | 74.49 | — | — | — | — |
| Al(2p) | 73.45 | 75.19 | — | — | — | — |
| Al(2s) | | 119.70 | — | — | — | — |
| Al(2s) | | 119.73 | — | — | — | — |
| Ti(2p) | — | — | 457.59 | 457.16 | — | — |
| Ti(2p) | — | — | 457.93 | 457.92 | — | — |
| Ti(2p) | — | — | 463.41 | 462.98 | — | — |
| Zr(3d) | — | — | — | — | 182.55 | 182.40 |
| Zr(3d) | — | — | — | — | 182.92 | 182.75 |
| Zr(3d) | — | — | — | — | 184.94 | 183.17 |
| Zr(3d) | — | — | — | — | 185.83 | 184.85 |
| Zr(3d) | — | — | — | — | | 185.29 |
| Br(3d) | | 68.45 | | | 72.47 | |
| Br(3d) | | 70.56 | | | | |
| S(2p) | | 169.69 | | | | |
| N(1s) | | | | 398.93 | | |
| N(1s) | | | | 401.01 | | |

XPS Analysis of Unmodified TiO₂ and DEOMP Modified TiO₂

Narrow line scan spectra of O(1s) of TiO₂ showed that there were three different binding energies for oxygen. The binding energies of 529.4 eV and 531.28 eV were assigned to the TiO₂ and P—O—Ti bonds of DEOMP modified TiO₂ nanoparticles respectively. Surface modification of TiO₂ with DEOMP resulted in a more asymmetric O(1s) peak where the peak at 531.3 eV was increased in percent area indicating the formation of P—O—Ti bonds. Ti(2p) emission of unmodified TiO₂ showed an intensity ratio of 1:1:1 whereas modified TiO₂ showed 5:2:3 intensity ratio of peaks. The TiO₂ DEOMP sample O(1s) spectrum showed bidentate P—O—Ti bonding (˜1:2 area ratio 531.3 eV:529.3 eV) and TiO₂ (528.3 eV). All 3 emissions shifted to lower binding energies upon modification. The P(2p) asymmetric peak of the modified TiO₂ could be fitted into a spin-doublet of 2 p_{3/2} and 2 p_{1/2} which corresponded to 131.8 eV and 132.9 eV emissions, respectively. The latter was assigned to P═O whereas the former emission as (hydrogen bonded) P—O.

XPS Analysis of Unmodified γ-Al₂O₃ and DEOMP Modified γ-Al₂O₃

The C(1s) emission peaks of the bare γ-Al₂O₃ are hydrocarbon contaminant (so called “smut”) from sample exposure to ambient atmosphere whereas the modified sample C(1s) spectrum showed carbons of the alkyl chain of DEOMP in addition to smut. The O(1s) spectrum of DEOMP modified γ-Al₂O₃ showed three peaks at 530.9 eV, 532.1 eV and 532.9 eV. The first was assigned as the γ-Al₂O₃ layer and remaining emission peaks were assigned as the P—O—Al, P═O bonds, respectively.

A spin-doublet for the P(2p) emission peak was also observed which was assigned as 2 p_{3/2} and 2 p_{1/2} with energies of 133.95 eV and 134.66 eV as P—O—R®=alkyl) and P═O bonds, respectively. The intensity ratio of the two de-convoluted peaks was ˜3:7, which matched closely with the intensity ratio of 1:1 reported in the literature (Chen et al. Bioelectrochemistry 2009, 75, 26).

The Al(2p) spectrum of the unmodified γ-Al₂O₃ showed two peaks with 72.8 eV and 73.45 eV, which were assigned as metallic Al and γ-Al₂O₃, respectively, which shifted to higher binding energies upon DEOMP modification. Upon modification with DEOMP, Al(2p) peaks appeared at 74.5 eV and 75.2 eV that were assigned to γ-Al2O3,46 as Al—O—P bonds and Al—O═P bonds. The metallic Al(2p) peak in the modified sample spectrum was not observed due to oxidation during the modification process (Forget et al. Appl. Surf Sci. 2003, 205, 44).

XPS Analysis of Unmodified ZrO₂ and DEOMP Modified ZrO₂

The O(1s) spectrum of DEOMP modified ZrO₂ showed three peaks at 530.3 eV, 531.6 eV and 533.4 eV, assigned to ZrO₂, P—O—Zr and P═O, P—O—R®=alkyl) bonding, respectively. The P(2p) spectrum of the modified ZrO₂ showed a spin doublet that had an intensity ratio of ˜1:3, which is comparable with that reported by Siddabattuni et al. (ACS Appl. Mater. Interfaces, 2013, 5, 1917), as 2p_{3/2} and 2p_{1/2} spin doublets. The spin doublet energies of 133.8 eV and 134.7 eV also match quite well with those previously reported for P—O—R®=alkyl) and P═O bonds (Moulder et al. Handbook of X-ray Photoelectron Spectroscopy; 2^{nd} ed.; Perkin-Elmer Corporation (Physical Electronics), 1992).

### Example 6

### Thermogravimetric Analyses (TGA) of Metal Oxide Nanoparticles

Thermogravimetric analysis (TGA) of the surface modified metal oxide nanoparticles was utilized to quantify the number of surface groups present and to estimate their area density on the surface of the metal oxide nanoparticles. A standard TGA weight loss measurement was carried out with a scan rate of 10° C./min. The ligand surface density was calculated using Equation 1 and TGA weight loss data. Sample mass was obtained after the bulk water loss up through 175° C. Volatile weight loss of ligand modified powder minus the volatile weight loss of the unmodified powder yielded the organic, volatile weight loss of the ligand. The calculation using the weight losses, molar mass of the volatile organic portion, and molar mass of the non-volatile inorganic portions of the ligand was also corrected for the amount of non-volatile mass added by the ligand.

$$\frac{{\dot{A}}^{2}}{group} = \frac{\begin{matrix}( surface area ( \frac{{m}^{2}}{g} ) ) \\ ( \begin{matrix}sample mass - \\ ( \frac{volatile wt loss}{mass per mol vol .} ) \\ ( mass non \text{-} volatile )\end{matrix} ) * {( {10}^{10} )}^{2}\end{matrix}}{6.023 \times {10}^{23} * ( volatile wt loss / mass per mol vol )} \qquad Equation 1$$

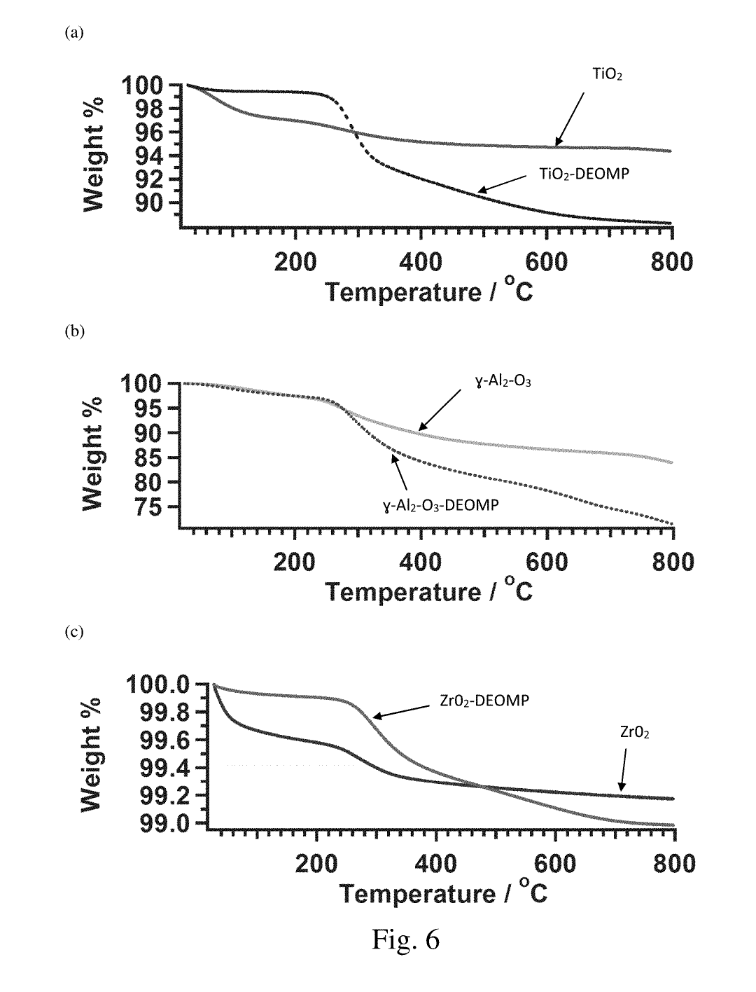

The TGA weight loss curves for TiO₂-DEOMP, λ-Al₂O₃-DEOMP, and ZrO₂-DEOMP, showing the surface modification as a weight loss of the volatile organic portion of the inorganic-organic surface ligand, are shown in FIG. 6. The surface density values for modified nanoparticles are shown in Table 3.

TABLE 3
Surface modified coverage values for metal-oxide
(metal = Ti, Al and Zr) nanoparticles analyzed
calculated from thermogravimetric weight loss.

| | | Estimated surface |
|---|---|---|
| | | Area/molecule |
| Oxide | Volatile Mass Loss (%) | (Å²/molecule) |
| Al₂O₃ | 25.55 | 13 |
| ZrO₂ | 0.919 | 15 |
| TiO₂ | 11.11 | 15 |

The TGA results confirmed the ¹³C CPMAS NMR surface modification results of the metal oxide nanoparticles. The highest surface density coverage was achieved with alumina particles, achieving an estimated 13 Å²/molecule, which is better than Helmy et al. (Langmuir 2002, 18, 8924) reported for C₁₈H₃₇P(O)(OH)₂ in his work with surface coverage of 1.48 molecules/nm². Excluding the multilayer bonding based on spectral analyses, we predicted that highly ordered self-assembled monolayers were obtained as surface modified γ-Al₂O₃ nanoparticles (i.e., as γ-Al₂O₃-DEOMP).

### Example 7

### Kinetics of Surface Modification of TiO₂ with DEOMP (1)

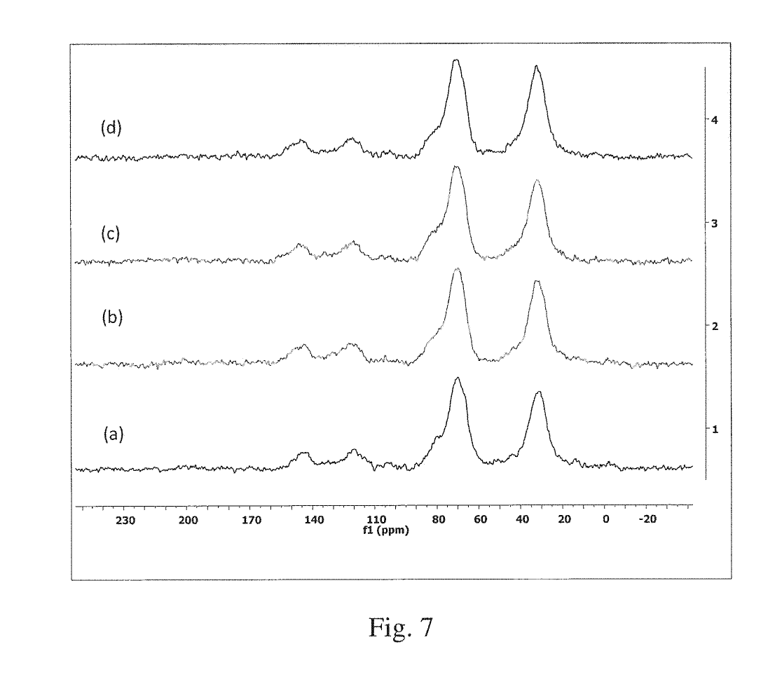

TiO₂ (1.00 g) was transferred to a 100 mL round bottom flask, toluene (˜15 mL) was added by a graduated pipette, and the slurry was sonicated for 30 min. DEOMP (1, 1.00 g, 5.2 mmol) was added to the flask, and the reaction mixture was maintained at refluxing temperature, with stirring, for 2 hr. Trimethylsilyl bromide (TMSBr, 2.8 mL, 1:4 mol eq. with respect to DEOMP) was added to the reaction mixture through a syringe. Methanol (50 μL, 1:0.25 mol eq.) was immediately added to the reaction mixture to begin hydrolysis of the phosphoryl-siloxyl bond to free phosphonic acid. Aliquots (3 mL) of the reaction mixture were drawn out by pipette at 15 min., 30 min., 1 hr., and 2 hr., from time of addition of methanol. The drawn aliquots were worked up as described in Example 5, and analyzed by TGA and solid state ¹³C CPMAS NMR (FIG. 7).

The analyses showed no discernable difference between the ¹³C CPMAS spectrum of the aliquots withdrawn at 15 min versus those withdrawn at 2 hr. This result indicates that the surface modification of TiO₂ can be significantly achieved within the first 15 minutes of the reaction. A materially simple, efficient, durable modification of the surface of TiO₂ particles is important for potential chemistry for bone implant.

### Example 8

### Surface Modified Coverage Values for DEOMP on Titania Nanopowder with Respect to Time of Reaction

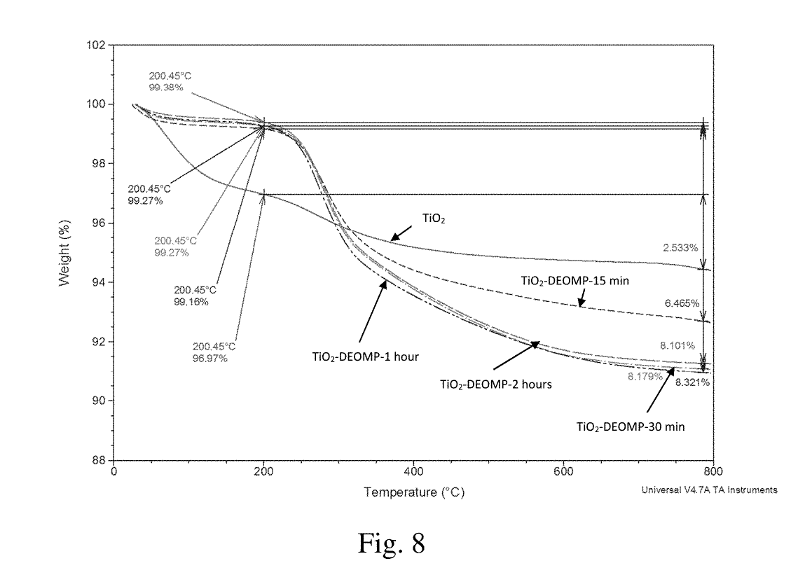

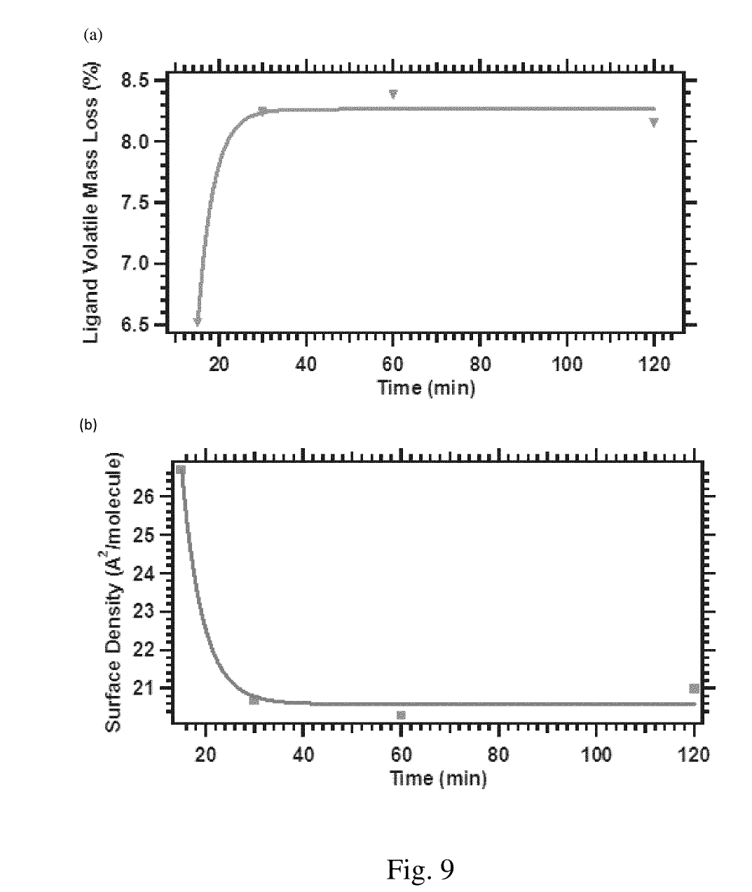

The surface modification reaction of the metal oxide nanoparticles from Example 7 was monitored with respect to time using TGA in support of ¹³C CPMAS analyses with the aim of quantifying the amount of groups added to the surface of the particles. A standard thermogravimetric analysis (TGA) weight loss measurement and related calculations were carried out as described in Example 6. The TGA weight loss curves for TiO₂-DEOMP, as a function of time of reaction, are shown in FIG. 8. FIG. 9a shows the % ligand volatile mass loss as a function of time of reaction. FIG. 9b shows change in surface density (Å²/molecule) as a function of time of reaction. TGA weight loss results suggest that a surface density of ˜20 Å²/ligand molecule was obtained in the first 30 minutes. Surface density values for DEOMP on titania nanopowder, with respect to time of reaction, are shown in Table 4.

TABLE 4
Surface modified coverage values for DEOMP on
titania nanopowder with respect to time of reaction.

| | | Estimated Surface |
|---|---|---|
| | | Area/molecule |
| Time | Volatile Mass Loss (%) | (Å²/molecule) |
| 15 min | 6.465 | 27 |
| 30 min | 8.101 | 21 |
| 1 hour | 8.321 | 20 |
| 2 hour | 8.179 | 21 |

### Example 9

### Effect of Alcohol Sterilization on the Surface Modification of TiO₂

TiO₂ (1.00 g) was transferred to a 100 mL three neck round bottom flask, toluene was added by a graduated pipette for a total dispersion weight of ˜17.5 g, and the slurry was sonicated for 40 min. DEOMP (1, 0.349 g, 1.8 mmol) and TMSBr (0.698 g, 4.5 mmol) were then added. The contents were further sonicated for 10 min in a closed flask, a reflux condenser and a dropping funnel attached, and the reaction mixture stirred and heated to 90° C. Once heating had begun, 1.5 mL of ethanol (8% of solution volume) was added dropwise through the dropping funnel over a period of 20 min. The slurry was then stirred for an additional 10 min. Stirring and heating were stopped, and the reaction mixture was cooled to room temperature and transferred to a centrifuge container.

The workup procedure was similar to that of surface modification of metal oxide nanoparticles by DEOMP for TiO₂, with the exception that the solvent was ethanol instead of toluene. After decanting the final ethanol wash, the precipitate was divided into two parts. One portion was transferred to a watch glass and the material dried at 130° C. in a conventional oven for 24 hr., while the other portion was dispersed in 12 mL of 70% (v/v) aqueous ethanol, stirred, and refluxed for 24 hr. in ethanol. The washed powder was dried in a conventional oven at 130° C. overnight. Both dried powder samples were analyzed by TGA.

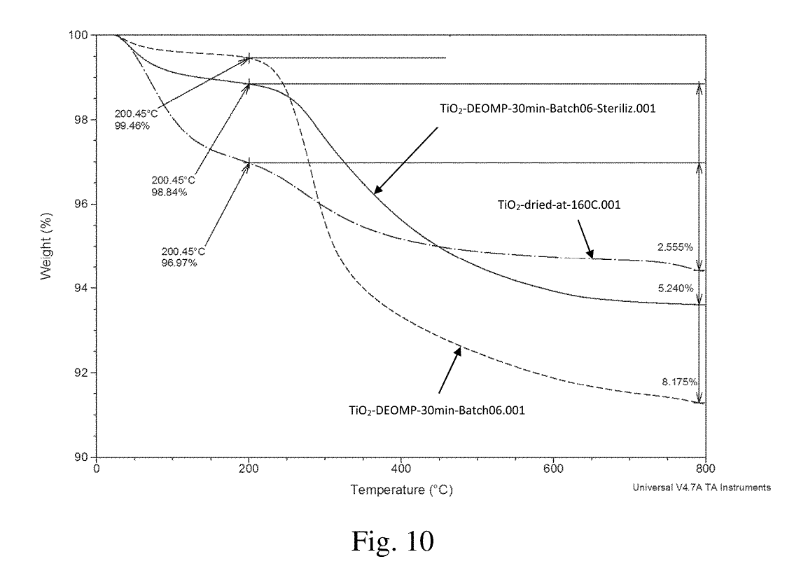

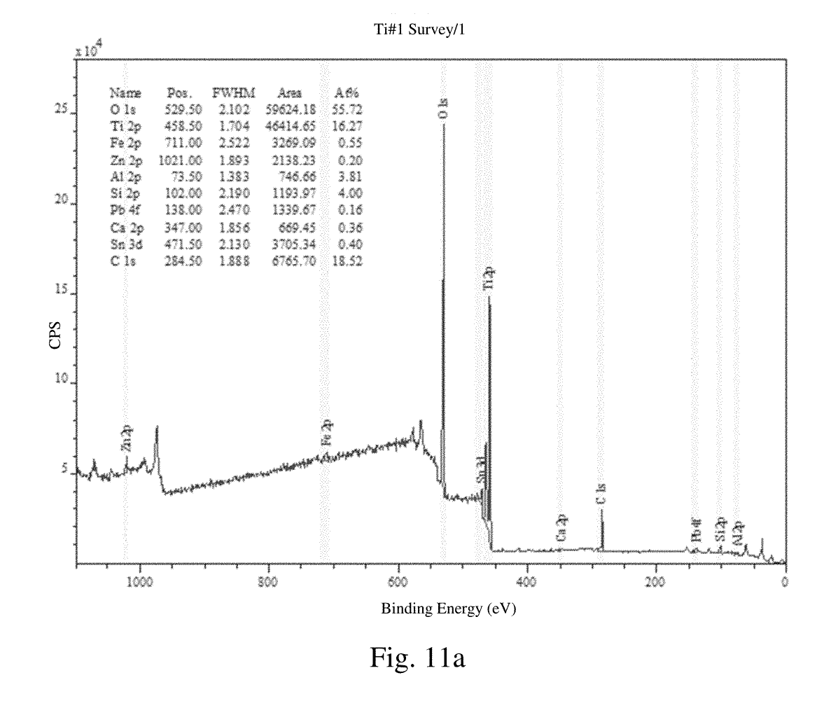

A standard thermogravimetric analysis (TGA) weight loss measurement and the related calculations were carried out as described in Example 6. This experiment provides support for long term solution sterilization, e.g., for alcohol sterilization of a metal implant device. Nearly three-fourths of the bound surface ligand was retained after sterilization (see Table 5, also FIG. 10).

TABLE 5
Surface Modified coverage values for TiO₂ after
30 min of reaction and after 24 hr. sonication soak
sterilization with ethanol (EtOH).

| | | Estimated |
|---|---|---|
| | | Surface coverage |
| | Volatile Mass | area/molecule |
| Time | Loss (%) | (Å²/molecule) |
| 30 min reaction followed by | 8.219 | 21 |
| overnight drying | | |
| 30 min reaction followed by 24 hour | 5.301 | 33 |
| sterilization in Ethanol, and | | |
| overnight drying | | |

### Example 10

### Surface Modification of Ti Metal with DEOMP (1)

One as-received Ti metal plate was rinsed with de-ionized water, and dried at 220° C. to remove adsorbed water (control surface composition). Two ¾″×¾″ Ti metal square plates were dual acid-etched according to the following procedure. The titanium plates were degreased in an ultrasound bath while immersed sequentially in hexane, methanol, acetone, and deionized distilled water, for 15 min each, followed by a dual acid, deoxidation etching (DAE) treatment.

The DAE procedure consisted of three acid treatments, with ultra-pure water (UPW) rinses between each step. During the first step of the DAE, the ¾″×¾″ titanium plates were treated with freshly prepared conc. HNO₃/conc. HF (8.33/0.075% (v/v)) for 12 min. The second step of the DAE consisted of treatment with conc. HCl/conc. H₂SO₄ (1:5 v/v) for 7 min. at 80° C. Finally, in the third step, the plates were placed in 40% (v/v) aqueous HNO₃ for 20 min at 50° C. The deoxidized plates were boiled in UPW for one hour, and then soaked in 70% (v/v) aqueous ethanol for 21 hr. The two plates were dried at 220° C. in a conventional oven.

DEOMP (1, 0.349 g) was added to a round bottom flask with toluene (15.3 mL), along with one titanium plate that had been acid etched, rinsed well, and oven dried, as described above, and the contents were sonicated for ˜5 min. TMSBr (0.698 g) was then added, and the contents were sonicated, while heating to 60° C. Absolute ethanol (3.53 mL, 2.792 g) was added dropwise during sonication. The plate was rinsed with toluene, and stored in 70% (v/v) ethanol for 40 hr. The titanium plate was then removed from the ethanol, dried at 180° C. for 5 min. in a conventional oven, and allowed to cool to room temperature. The three plates, as received, deoxidized, and DEOMP treated, were analyzed by XPS.

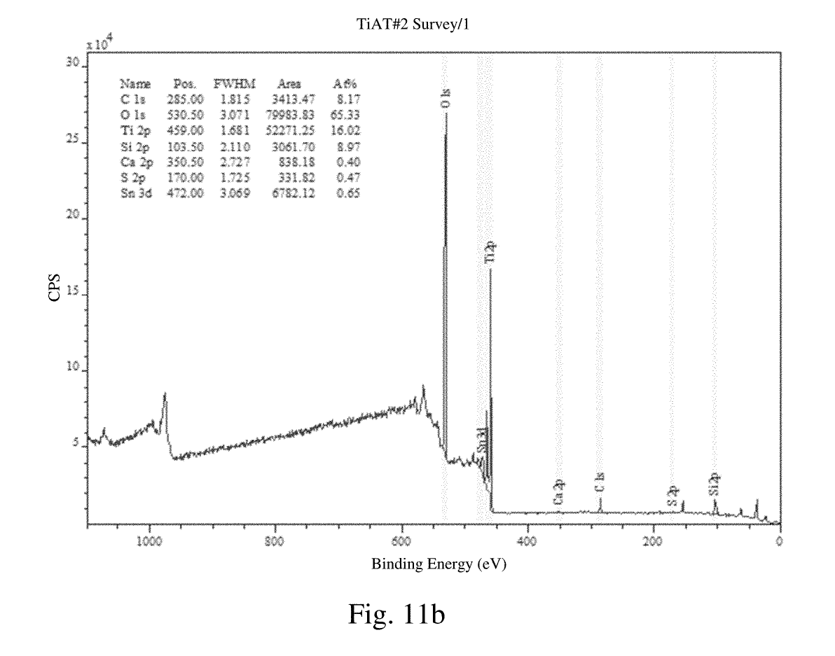

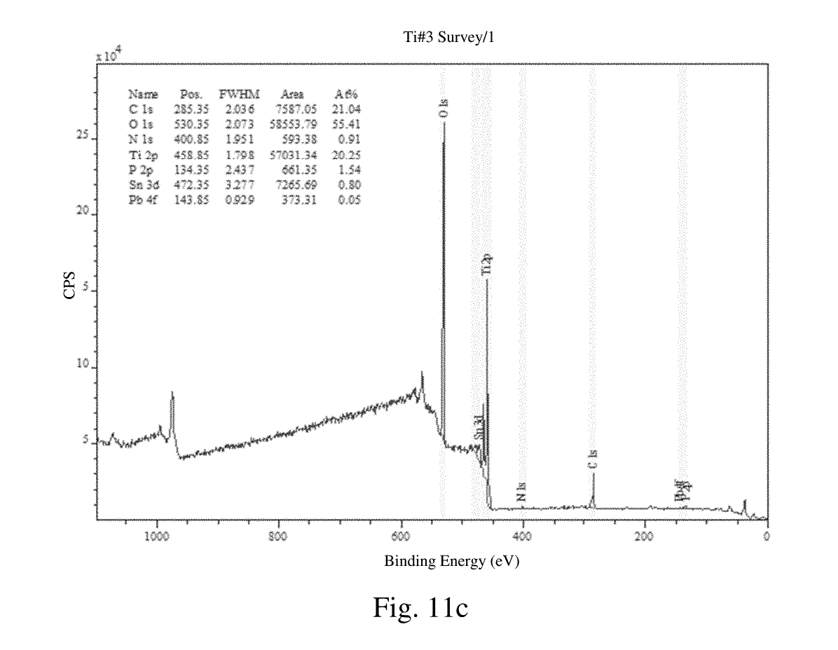

The XPS procedure and analysis was performed as above. XPS atomic concentration data for as-received-Ti metal, acid-treated-Ti metal, and DEOMP modified Ti metal are shown in Table 6 and FIG. 11a-11c. Comparison of wide scan XPS survey spectra of as-received Ti, acid-treated Ti, and DEOMP modified Ti metal specimens showed a 1.54% atomic concentration of phosphorous on titanium after DEOMP modification. Further, in DEOMP modified Ti, the amount of carbon content was also increased significantly compared to acid-treated-Ti indicating the surface modification of Ti with DEOMP. Acid treatment and DEOMP modification also reduced the surface concentration of other impurity metal oxides and salts, e.g., sulfate, carbonate and silicate.

TABLE 6
XPS atomic concentration data for as-received-Ti metal, acid-treated-Ti
metal, and DEOMP modified titanium metal.

| | Atomic Concentration (%) | | | | | | | | | | | | |
|---|---|---|---|---|---|---|---|---|---|---|---|---|---|
| Ti | C | O | Ti | Sn | Pb | Ca | P | N | Si | S | Fe | Al | Zn |
| sample | (1s) | (1s) | (2p) | (3d) | (4f) | (2p) | (2p) | (1s) | (2p) | (2p) | (2p) | (2p) | (2p) |
| As-received | 18.5 | 55.7 | 16.2 | 0.40 | 0.16 | 0.36 | — | — | 4.00 | — | 0.55 | 3.81 | 0.20 |
| Acid-treated | 8.17 | 65.3 | 16.0 | 0.65 | — | 0.40 | — | — | 8.97 | 0.47 | — | — | — |
| Ti-DEOMP | 21.0 | 55.4 | 20.2 | 0.80 | 0.05 | — | 1.54 | 0.91 | — | — | — | — | — |

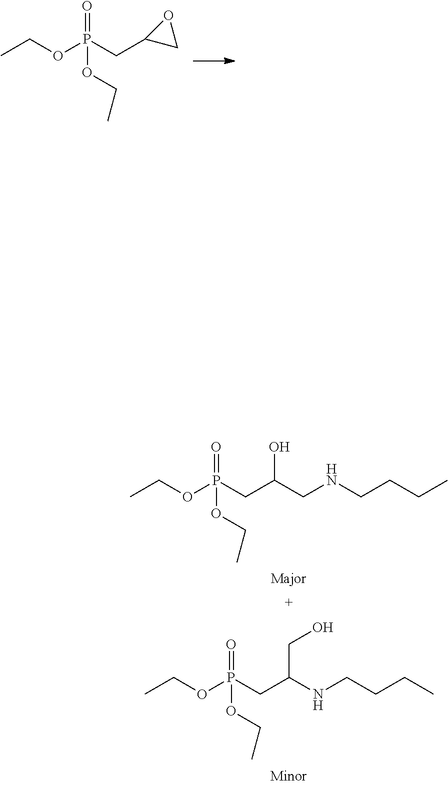

### Example 11

### Synthesis of diethyl 3-(butylamino)-2-hydroxypropylphosphonate (5) and 2-(butylamino)-3-hydroxypropylphosphonate (6)

DEOMP (0.970 g, 5 mmol) and butyl-1-amine (0.438 g, 6 mmol) were added to a round bottom flask at 0° C., and allowed to warm to room temperature overnight with stirring (18-96 hours). The resulting products, 67% diethyl 3-(butylamino)-2-hydroxypropylphosphonate (5) and 33% diethyl 2-(butylamino)-3-hydroxypropylphosphonate (6), were obtained nearly quantitatively, and the reaction mixture was characterized by NMR and FTIR. The product ratio was comparable to the product ratio observed by Azizi and Saidi (Org. Lett. 2005, 7, 3649-3651) during an analogous study, where they observed high chemoselectivity with a product ratio of 3:1 for the terminal carbon substitution reaction between 2-phenyloxirane and butyl-1-amine. Compound 5: ¹H NMR (CDCl₃, 400 MHZ): 0.803-0.857 (m, 3H, —CH₃), 1.216-1.309 (m, 1H, —CH₂—), 1.250 (t, J=7.2 Hz, 6H, —CH₃), 1.382-1.505 (m, 2H, —CH₂—), 1.797-1.993 (m, 2H, —PCH₂—), 2.505-2.625 (m, 2H, —NHCH₂—), 2.669-2.732 (m, 2H, —NHCH₂—), 3.972-4.082 (m, 4H, —OCH₂—), 4.164 (s, 1H, —OH), 4.108-4.205 (m, 1H, —OCH—) ppm.; ¹³C NMR (CDCl₃, 100 MHZ): 14.03 (—CH₃), 16.47 (—CH₃), 16.53 (—CH₃), 20.43 (—CH₂—), 31.07-32.46 (JP—C=139.0 Hz, —PCH₂—), 31.75 (—CH₂—), 49.34 (—NH₂CH₂—), 55.65-55.81 (JP—C=16 Hz, —CH₂—), 61.78-61.98 (—OCH₂—), 64.80 (—CH—) ppm.; IR (CDCl₃) cm−1: 3339 (—OH, —NH). Compound 6: 1H NMR (CDCl₃, 400 MHZ): 0.803-0.857 (m, 3H, —CH₃), 1.121-1.309 (m, 1H, —CH₂—), 1.250 (t, J=7.2 Hz, 6H, —CH₃), 1.382-1.505 (m, 2H, —CH₂—), 1.797-1.993 (m, 2H, —PCH₂—), 2.239-2.625 (m, 2H, —NHCH₂—), 2.669-2.732 (m, 2H, —NHCH₂—), 3.972-4.082 (m, 4H, —OCH₂—), 4.164 (s, 1H, —OH), 4.108-4.205 (m, 1H, —OCH—) ppm.; ¹³C NMR (CDCl₃, 100 MHZ): 13.86 (—CH₃), 16.46 (—CH₃), 16.53 (—CH₃), 20.01 (—CH₂), 31.75-33.20 (JP—C=145.0 Hz, —PCH₂), 40.81, 57.96, 61.78-61.98 (—OCH₂—), 64.76 (—CH₂—) ppm.; IR (CDCl₃) cm−1: 3339 (—OH, —NH). Compounds 5+6: IR (CDCl₃) cm⁻¹: 3339 (—OH), 2958, 2931, 2873, 1444, 1392, 1229, 1164, 962, 834, 548.

The reactivity of DEOMP as an epoxy coupling agent was tested with a model reaction with n-butylamine to obtain a mixture of 5 and 6. The FTIR spectra clearly showed a new —OH absorption by the 5 (+6) at 3339 cm⁻¹, which confirmed the hydrolysis of oxirane moiety. The —NH peak of the 5 (+6) is not distinct, but appears at ˜3300 region and hence overlaps with hydroxyl. FTIR spectra also showed the epoxy ring vibration at 872 cm⁻¹ of DEOMP was absent in FTIR of 5 (+6), further supporting reaction of the oxirane moiety.

¹H NMR and ¹³C NMR data more clearly supported the formation of 5 and 6. Comparison of ¹H NMR spectra of DEOMP, n-butyl amine and 5 (+6) showed that the diastereotopic proton peaks adjacent to phosphorous appeared at 1.8-1.9 ppm, whereas the proton on secondary carbon and the —OH peak showed at ˜4.2 ppm. The other major difference between the ¹H NMR spectra of the two reactants and the product mixture was the appearance of two distinct —CH₂— peaks over 2.5-2.7 ppm, which were structurally adjacent to the —NH group.

Comparison of ¹³C NMR spectra of DEOMP, n-butyl amine and 5 (+6) mixture showed a new peak at 64.80 ppm, which had been assigned to the chiral carbon bearing a hydroxyl group. The —CH₂— peak of the oxirane ring shifted from 46.9 ppm to 55.7-55.8 region upon coupling with n-butylamine. In addition, the —CH₂ group next to NH₂ of n-butyl amine shifted to 49.3 ppm from 41.9 ppm after coupling with DEOMP. These major peak shifts supported DEOMP and n-butylamine coupling to give 5 and 6.

### Example 12

### Reaction Between DEOMP Modified γ-Al₂O₃ with Butyl-1-Amine

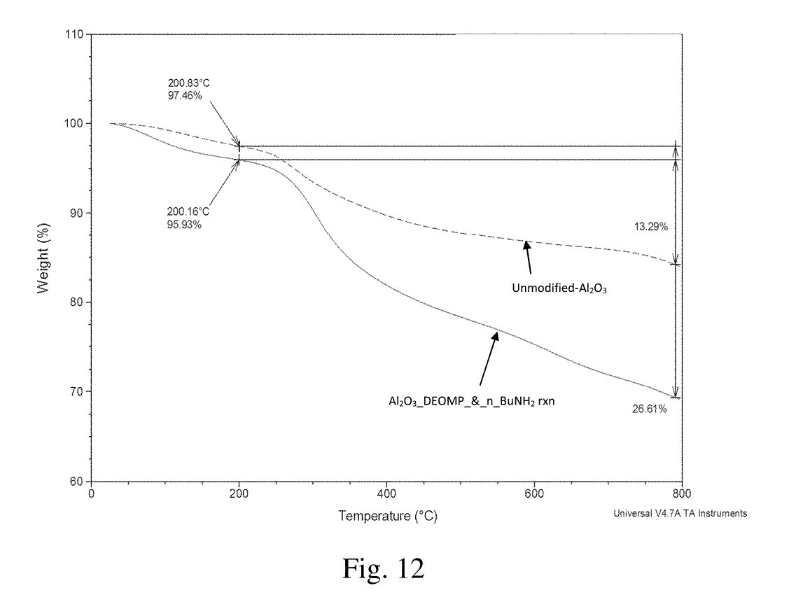

γ-Al₂O₃-DEOMP (0.750 g) and anhydrous toluene (˜30 mL) were added to a round bottom flask and the contents sonicated for ˜5 min prior to the addition of butyl-1-amine (1.020 g). The flask and contents were sonicated for a further 5 min, and stirred at room temperature overnight. The contents were vacuum filtered through a micropore filter membrane (0.45 m pore), and washed with toluene (3×) to remove excess butyl-1-amine. The powder was dried in a conventional oven at 130° C. overnight and subjected to TGA analysis. A standard thermogravimetric analysis (TGA) weight loss measurement and the related calculations were carried out as described in Example 6. FIG. 12 depicts the TGA traces showing the mass loss of: (a) Unmodified Al₂O₃; and (b) Al₂O₃-DEOMP vs. n-butylamine reaction.

The results of TGA analysis of the γ-Al₂O₃-DEOMP-butylamine sample showed butylamine surface coverage of 12 Å²/molecule. The reaction between γ-Al₂O₃-DEOMP and n-butyl amine occurred in an approximately 1:1 butylamine:DEOMP ratio, which was identical within measurement error to the measured DEOMP surface area per ligand group density (Table 7). The result supports use of γ-Al₂O₃-DEOMP epoxy group as a surface reactive coupling agent. In addition, the measured ratio also supports monolayer coverage of the DEOMP on the surface of the alumina, since a multilayer structure should reduce the amount of butyl amine reacted with particles.

TABLE 7
Surface modified coverage values for DEOMP modified
γ-Al₂O₃ and butyl-1-amine reactions.

| | | | | | Ligand, | |
|---|---|---|---|---|---|---|
| | | Adsorbed | | Oxide | volatile | Surface |
| | Area/mass | water | Sample | mass | mass loss | coverage |
| Oxide | (m²/g) | mass (%) | mass (%) | loss (%) | (%) | (Å²/group) |
| Al₂O₃-DEOMP | 180 | 1.667 | 98.333 | 13.200 | 11.333 | 12.9 |
| Al₂O₃-DEOMP- | 180 | 4.070 | 95.930 | 13.636 | 26.610 | 12.1 |
| NHBu | | | | | | |

### Example 13

### Particle Dispersion Analysis

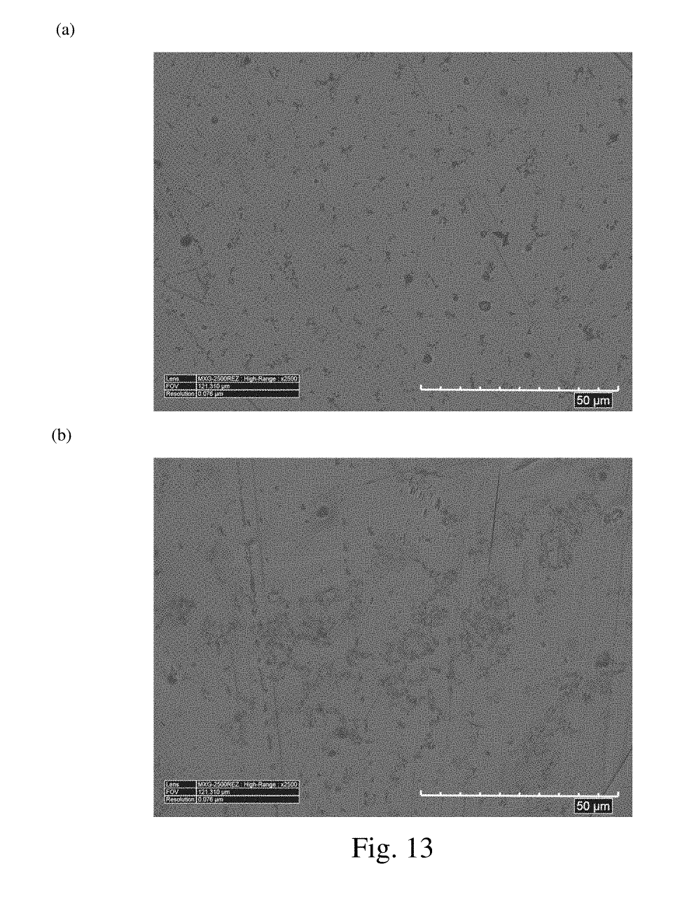

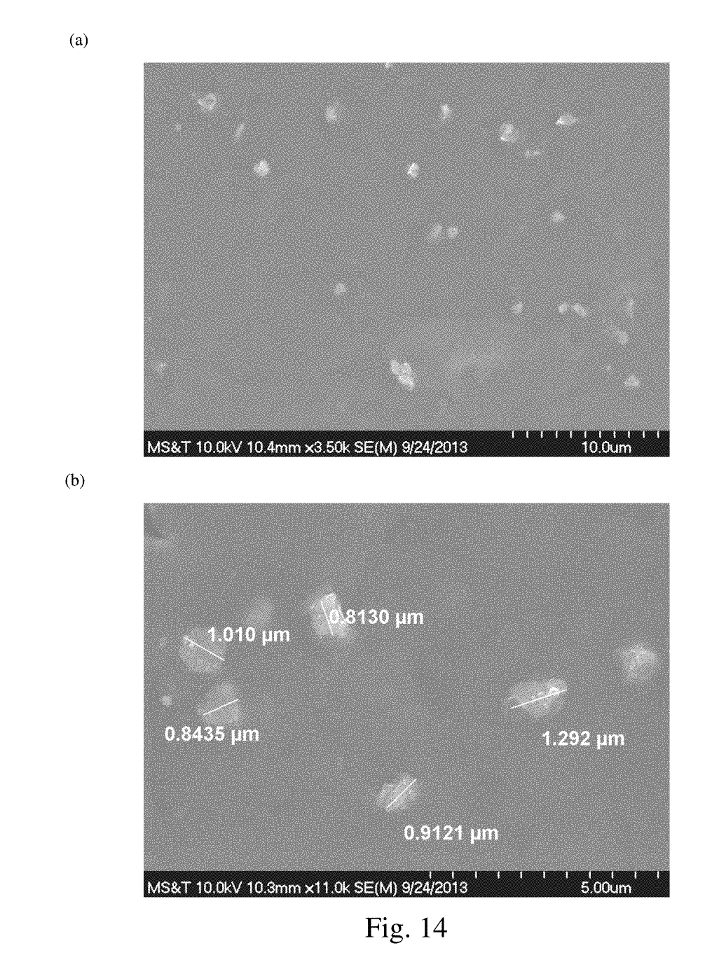

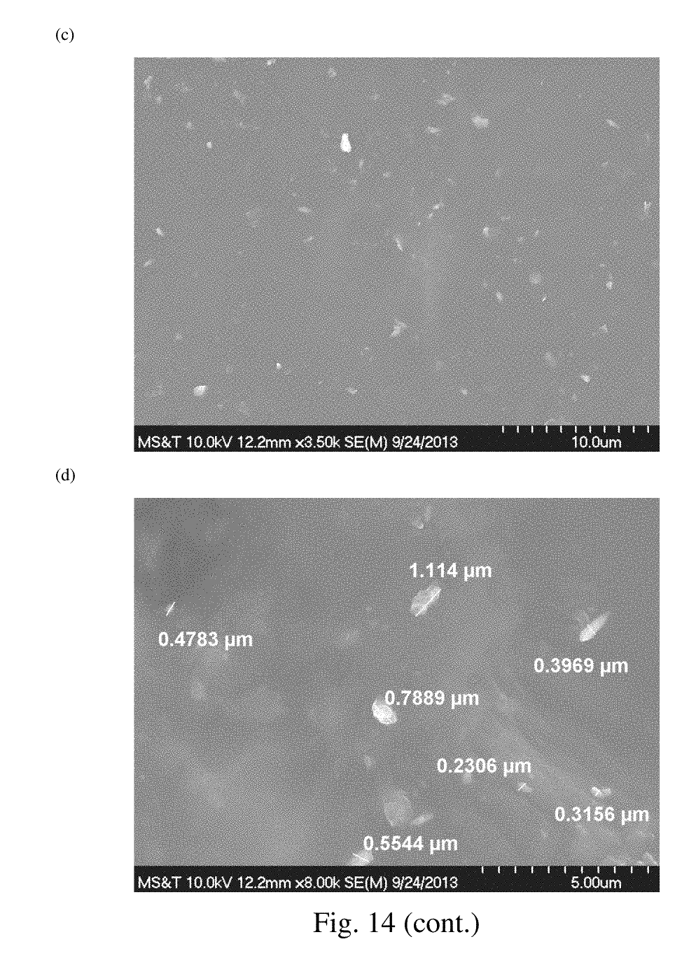

Epoxy monomer (5.00 g, 50 wt.-% of final mixture, epoxy equivalent weight=158) and unmodified/DEOMP-modified, γ-Al₂O₃ (0.050 g, 0.5 wt.-% of final mixture) were added to a small plastic container, and homogenized (500 W power, PowerGen 1000 homogenizer, Fisher Scientific, St. Louis, Mo., USA) for 20 minutes. The mixture was treated with a sonicator probe (900 W, Vibra Cell, Sonics & Materials Inc. Danbury, Conn., USA) for 5 min. (30 sec., 10×) at 1 minute intervals between, with immersion in an ice bath after each 30 second sonication (required to remove the heat input during sonication). The reagent, 4 methyl-cyclohexanedicarboxylic anhydride (MHHPA, 4.850 g, 48.5 wt.-% of final mixture), was then added to the above mixture and magnetically stirred overnight. Then 2-ethyl-4-methylimidazole (0.100 g, 1 wt.-% of final mixture) was added and stirred for a further 30-60 minutes. The formulations were placed in a vacuum oven at room temperature for 30 minutes to remove entrapped air, heated in aluminum pans at 120° C. for 24 hours, and allowed to cool to room temperature, to polymerize the composite matrix. Each sample was then polished using a water lubricated mineral polishing wheel from 60 to stepwise successively finer grit of sandpapers through 1200 grit carbide paper. A cross section of each sample was viewed under optical microscope and, after standard gold sputter, under a field emission scanning electron microscope (FE SEM) to determine agglomeration and particle size of the unmodified γ-Al₂O₃ and modified γ-Al₂O₃-DEOMP particles (see FIGS. 13 and 14).

Optical microscopic images (FIG. 13) and FE-SEM images (FIG. 14) were obtained which supported that improved dispersion quality was obtained for γ-Al₂O₃-DEOMP nanoparticles into organic matrix composites over that of unmodified alumina in the same organic epoxy matrix. The bright field images of FE-SEM showed randomly dispersed unmodified/modified alumina nanoparticles in the epoxy nanocomposite formulation. The optical and FE-SEM images both show that the unmodified γ-Al₂O₃ has both larger and increasingly clustered agglomerates of nanoparticles with greater interstitial space found between aggregates, as compared to the DEOMP modified γ-Al₂O₃ nanoparticles. In comparison, the surface modified particle dispersion was a more diffuse dispersion of both smaller and better distributed aggregates. Unmodified γ-Al₂O₃ nanoparticles have polar —OH groups on the surface, hence they tend to aggregate, whereas the DEOMP modified γ-Al₂O₃ have organic surface groups to promote organic matrix dispersion, hence they do not aggregate as much as the unmodified γ-Al₂O₃ particles. Further, FE-SEM images also showed that the resulting particle size of the γ-Al₂O₃-DEOMP was smaller by an order of magnitude compared to unmodified alumina epoxy nanocomposites, which indicated comparatively good dispersion quality.

1. A method of forming a surface-modified substrate, said method comprising:
(a) providing a substrate having a surface, said surface comprising an oxide and/or an —OH group thereon;
(b) providing a compound comprising an ester group and an epoxy ring;
(c) reacting said compound with said oxide and/or said —OH group so as to yield the surface-modified substrate, said epoxy ring remaining intact after said reacting.

2. The method of claim 1, wherein said surface comprises a plurality of oxide and/or —OH groups, and said compound reacts with at least two moieties selected from the group consisting of oxide and —OH.

3. The method of claim 1, wherein said substrate comprises a metal.

4. The method of claim 3, wherein said substrate comprises a metal selected from the group consisting of group 1B, 2B, 4B, 5B, 6B, 7B, 8, 3A, 4A, 5A, the lanthanides, the actinides, and alloys and mixtures thereof.

5. The method of claim 4, wherein said metal is selected from the group consisting of titanium, zirconium, iron, nickel, aluminum, copper, stainless steel, NiTi alloy, brass, and alloys and mixtures thereof.

6. The method of claim 3, wherein said metal is in a form selected from the group consisting of particles, nanoparticles, scintered powder, and free powder.

7. The method of claim 4, wherein said substrate comprises a metal oxide selected from the group consisting of titanium oxide, zirconium oxide, and aluminum oxide.

8. The method of claim 1, wherein said compound comprises two ester groups.

9. The method of claim 8, wherein a single molecule of said compound reacts with at least two moieties from the group consisting of oxide and —OH groups.

10. The method of claim 9, wherein said single molecule of said compound reacts with three moieties from the group consisting of oxide and —OH groups.

11. The method of claim 1, wherein at least about 10% of —OH groups present on said surface react with said compound during said reacting.

12. The method of claim 1, wherein said compound is a phosphonate.

13. The method of claim 12, wherein said phosphonate is O,O-dialkyl oxiran-2-yl methyl phosphonate ester.

14. The method of claim 1, wherein said reacting is carried out in situ.

15. The method of claim 1, wherein said reacting further comprises hydrolyzing said compound.

16. The method of claim 1, further comprising
(d) addition of a nucleophile.

17. The method of claim 16, wherein said nucleophile is selected from the group consisting of amines, alcohols, thiols, carboxylates, Grignard reagents, and carbon anions.

18. The method of claim 16, wherein said nucleophile is selected from the group consisting of telechelic macromolecules, proteins, enzymes, proteins, polysaccharides, antibodies, antigens, hydrophilic polymers, and oligonucleotides.

19. The method of claim 16, wherein said nucleophile comprises a linker agent and a molecule selected from the group consisting of telechelic macromolecules, proteins, enzymes, proteins, polysaccharides, antibodies, antigens, and oligonucleotides.

20. A method of forming a surface-modified substrate, said method comprising:
(a) providing a substrate having a surface, said surface comprising an oxide and/or an —OH group thereon;
(b) providing a compound comprising an ester group and a functionalized epoxy ring;
(c) reacting said compound with said oxide and/or said —OH group so as to yield the surface-modified substrate.

21. The method of claim 20, wherein said surface comprises a plurality of oxide and/or —OH groups, and said compound reacts with at least two moieties selected from the group consisting of oxide and —OH.

22. The method of claim 20, wherein said substrate comprises a metal.

23. The method of claim 22, wherein said substrate comprises a metal selected from the group consisting of group 1B, 2B, 4B, 5B, 6B, 7B, 8, 3A, 4A, 5A, the lanthanides, the actinides, and alloys and mixtures thereof.

24. The method of claim 23, wherein said metal is selected from the group consisting of titanium, zirconium, iron, nickel, aluminum, copper, stainless steel, NiTi alloy, brass, and alloys and mixtures thereof.

25. The method of claim 22, wherein said metal is in a form selected from the group consisting of particles, nanoparticles, scintered powder, and free powder.

26. The method of claim 23, wherein said substrate comprises a metal oxide selected from the group consisting of titanium oxide, zirconium oxide, and aluminum oxide.

27. The method of claim 20, wherein said compound comprises two ester groups.

28. The method of claim 27, wherein a single molecule of said compound reacts with at least two moieties from the group consisting of oxide and —OH groups.

29. The method of claim 28, wherein said single molecule of said compound reacts with three moieties from the group consisting of oxide and —OH groups.

30. The method of claim 20, wherein at least about 10% of —OH groups present on said surface react with said compound during said reacting.

31. The method of claim 20, wherein said compound is a phosphonate.

32. The method of claim 31, wherein said phosphonate is the product of the reaction of O,O-dialkyl oxiran-2-yl methyl phosphonate ester with a nucleophile.

33. The method of claim 20, wherein said reacting is carried out in situ.

34. The method of claim 20, wherein said reacting further comprises hydrolyzing said compound.

35. The method of claim 32, wherein said nucleophile is selected from the group consisting of amines, alcohols, thiols, carboxylates, Grignard reagents, and carbon anions.

36. The method of claim 32, wherein said nucleophile is selected from the group consisting of telechelic macromolecules, proteins, enzymes, proteins, polysaccharides, antibodies, antigens, hydrophilic polymers, and oligonucleotides.

37. The method of claim 32, wherein said nucleophile comprises a linker agent and a molecule selected from the group consisting of telechelic macromolecules, proteins, enzymes, proteins, polysaccharides, antibodies, antigens, and oligonucleotides.
